(19) United States
(12) Patent Application Publication
(10) Pub. No.: US 2025/0123061 A1
(43) Pub. Date: Apr. 17, 2025

(54) HEAT EXCHANGER AND WATER HEATER

(71) Applicant: WUHU MIDEA SMART KITCHEN APPLIANCE MANUFACTURING CO., LTD., Wuhu (CN)

(72) Inventors: Yangjian CHEN, Wuhu (CN); Yuehua CHEN, Wuhu (CN); Jianjun WANG, Wuhu (CN)

(21) Appl. No.: 18/730,987

(22) PCT Filed: May 26, 2023
(86) PCT No.: PCT/CN2023/096549

§ 371 Date: Jul. 22, 2024

(30) Foreign Application Priority Data
Dec. 30, 2022 (CN) 202211737078.2
Dec. 30, 2022 (CN) 202223598354.X

(51) Int. Cl. F28F 1/12; F24H 9/00; F24H 9/14

(52) U.S. Cl. CPC F28F 1/12; F24H 9/0036; F24H 9/146; F28F 2215/00

(57) ABSTRACT

A heat exchanger includes a housing, and a combustion chamber, a heat exchange chamber, and a condensation chamber provided inside the housing and sequentially arranged along a flue gas flow direction in the housing. The heat exchanger further includes combustion-chamber heat-exchange tubes provided in the combustion chamber, heat-exchange-chamber heat-exchange tubes provided in the heat exchange chamber and in communication with the combustion-chamber heat-exchange tubes, and condensation-chamber heat-exchange tubes provided in the condensation chamber and in communication with the heat-exchange-chamber heat-exchange tubes.

### CROSS-REFERENCE TO RELATED APPLICATION

This application is based on and claims priority to Chinese Patent Application No. 202211737078.2 and No. 202223598354.X, filed on Dec. 30, 2022, the entire contents of which are incorporated herein by reference.

### TECHNICAL FIELD

The present disclosure relates to the field of water heater technologies, and more particularly, to a heat exchanger and a water heater.

### BACKGROUND

In the related art, flue gas discharged from a gas water heater has a large amount of heat. Since the heat in the flue gas cannot be exchanged with water in a heat exchanger, energy is not fully utilized, resulting in the energy efficiency of the water heater not reaching high standards and energy being wasted. Therefore, there is room for improvement in the heat exchanger and the water heater.

### SUMMARY

The present disclosure aims to solve one of the above technical problems in the related art at least to a certain extent. To this end, the present disclosure provides a heat exchanger that has higher heat exchange efficiency, avoiding energy waste caused by a direct discharge of heat in flue gas. The flue gas further exchanges heat with water in a condensation heat exchange part, and the water heater is able to reach a high standard of energy efficiency.

The present disclosure further provides a water heater having the above-mentioned heat exchanger.

According to embodiments of the present disclosure, the heat exchanger includes: a housing internally having a combustion chamber, a heat exchange chamber, and a condensation chamber, the combustion chamber, the heat exchange chamber, and the condensation chamber being sequentially arranged along a flue gas flow direction within the housing; combustion-chamber heat-exchange tubes provided in the combustion chamber; heat-exchange-chamber heat-exchange tubes provided in the heat exchange chamber and in communication with the combustion-chamber heat-exchange tubes; and condensation-chamber heat-exchange tubes provided in the condensation chamber and in communication with the heat-exchange-chamber heat-exchange tubes.

According to the heat exchanger of the embodiments of the present disclosure, the heat exchanger has higher heat exchange efficiency, avoiding energy waste caused by the direct discharge of heat from the flue gas. The flue gas further exchanges heat with water in the condensation heat exchange part, and the water heater is able to reach a high standard of energy efficiency.

In addition, the heat exchanger according to the embodiments of the present disclosure may have following additional technical features.

According to some embodiments of the present disclosure, a plurality of rows of the condensation-chamber heat-exchange tubes are arranged along the flue gas flow direction.

According to some embodiments of the present disclosure, the condensation-chamber heat-exchange tubes are at least partially divided into a plurality of groups, and each of the plurality of groups includes at least two condensation-chamber heat-exchange tubes arranged in parallel.

According to some embodiments of the present disclosure, at least two condensation-chamber heat-exchange tubes in a same row of the condensation-chamber heat-exchange tubes are connected in parallel.

According to some embodiments of the present disclosure, at least two condensation-chamber heat-exchange tubes in a plurality of adjacent rows of the condensation-chamber heat-exchange tubes are connected in parallel.

According to some embodiments of the present disclosure, the at least two condensation-chamber heat-exchange tubes connected in parallel are located in at least two adjacent rows.

According to some embodiments of the present disclosure, the condensation-chamber heat-exchange tubes are arranged in three rows.

According to some embodiments of the present disclosure, two downstream and midstream rows of the condensation-chamber heat-exchange tubes are grouped in a parallel connection along the flue gas flow direction.

According to some embodiments of the present disclosure, each group includes one condensation-chamber heat-exchange tube in the downstream row and one condensation-chamber heat-exchange tube in the midstream row.

According to some embodiments of the present disclosure, in an upstream row of the condensation-chamber heat-exchange tubes, at least two adjacent condensation-chamber heat-exchange tubes in the same row are grouped in a parallel connection.

According to some embodiments of the present disclosure, the two downstream and midstream rows of the condensation-chamber heat-exchange tubes grouped in a parallel connection include a greater number of condensation-chamber heat-exchange tubes than the upstream row of the condensation-chamber heat-exchange tubes grouped in a parallel connection.

According to some embodiments of the present disclosure, a plurality of row of the heat-exchange-chamber heat-exchange tubes are arranged along the flue gas flow direction.

According to some embodiments of the present disclosure, each of the plurality of rows of the heat-exchange-chamber heat-exchange tubes is arranged in series.

According to some embodiments of the present disclosure, a plurality of rows of the combustion-chamber heat-exchange tubes are arranged along the flue gas flow direction.

According to some embodiments of the present disclosure, each of the plurality of rows of the combustion-chamber heat-exchange tubes being arranged in parallel.

According to some embodiments of the present disclosure, the housing includes a first water box bottom plate, a second water box bottom plate, a first water box cover plate, and a second water box cover plate.

According to some embodiments of the present disclosure, the first water box cover plate covers the first water box bottom plate and defines a plurality of first water boxes with the first water box bottom plate.

According to some embodiments of the present disclosure, each of the plurality of first water boxes is in communication with a first end of at least one corresponding condensation-chamber heat-exchange tube.

According to some embodiments of the present disclosure, the second water box cover plate covers the second water box bottom plate and defines a plurality of second water boxes with the second water box bottom plate.

According to some embodiments of the present disclosure, each of the plurality of second water boxes is in communication with a second end of at least one corresponding condensation-chamber heat-exchange tube.

According to some embodiments of the present disclosure, a first one of the plurality of first water boxes is connected to a water inlet of the heat exchanger.

According to some embodiments of the present disclosure, liquid in the first one of the plurality of first water boxes is configured to flow into a corresponding first one of the plurality of second water boxes through the corresponding condensation-chamber heat-exchange tube.

According to some embodiments of the present disclosure, the liquid in the first one of the plurality of second water boxes is then configured to flow into a corresponding second one of the plurality of first water boxes through the corresponding condensation-chamber heat-exchange tube, and the liquid is configured to flow in this way until flowing through all the condensation-chamber heat-exchange tubes to a last one of the plurality of second water boxes.

According to some embodiments of the present disclosure, a plurality of third water boxes are defined between the first water box cover plate and the first water box bottom plate.

According to some embodiments of the present disclosure, a plurality of fourth water boxes are defined between the second water box cover plate and the second water box bottom plate.

According to some embodiments of the present disclosure, each of the plurality of third water boxes is in communication with a first end of at least one corresponding heat-exchange-chamber heat-exchange tube.

According to some embodiments of the present disclosure, each of the plurality of fourth water boxes is in communication with a second end of at least one corresponding heat-exchange-chamber heat-exchange tube.

According to some embodiments of the present disclosure, a first one of the plurality of fourth water boxes is in communication with the last one of the plurality of second water boxes.

According to some embodiments of the present disclosure, liquid in the first one of the plurality of fourth water boxes is configured to flow into a corresponding first one of the plurality of third water boxes through the corresponding heat-exchange-chamber heat-exchange tube.

According to some embodiments of the present disclosure, the liquid in the first one of the plurality of third water boxes is then configured to flow into a corresponding second one of the plurality of fourth water boxes through the corresponding heat-exchange-chamber heat-exchange tube, and the liquid is configured to flow in this way until flowing to a last one of the plurality of fourth water boxes.

According to some embodiments of the present disclosure, the heat exchanger further includes a third water box bottom plate, a fourth water box bottom plate, a third water box cover plate, and a fourth water box cover plate.

According to some embodiments of the present disclosure, the third water box cover plate covers the third water box bottom plate and defines a plurality of fifth water boxes with the third water box bottom plate.

According to some embodiments of the present disclosure, each of the plurality of fifth water boxes is in communication with a first end of at least one corresponding heat-exchange-chamber heat-exchange tube.

According to some embodiments of the present disclosure, the fourth water box cover plate covers the fourth water box bottom plate and defines a plurality of sixth water boxes with the fourth water box bottom plate.

According to some embodiments of the present disclosure, each of the plurality of sixth water boxes is in communication with a second end of at least one corresponding heat-exchange-chamber heat-exchange tube.

According to some embodiments of the present disclosure, at least one heat-exchange-chamber heat-exchange tube is connected between a first one of the plurality of fifth water boxes and a last one of the plurality of fourth water boxes.

According to some embodiments of the present disclosure, liquid in the first one of the plurality of fifth water boxes is configured to flow into a corresponding first one of the plurality of sixth water boxes through the corresponding heat-exchange-chamber heat-exchange tube.

According to some embodiments of the present disclosure, the liquid in the first one of the plurality of sixth water boxes is then configured to flow into a corresponding second one of the plurality of fifth water boxes through the corresponding heat-exchange-chamber heat-exchange tube, and the liquid is configured to flow in this way until flowing to a last one of the plurality of fifth water boxes.

According to some embodiments of the present disclosure, one seventh water box is defined between the third water box cover plate and the third water box bottom plat.

According to some embodiments of the present disclosure, the one seventh water box is in communication with a first end of at least one corresponding combustion-chamber heat-exchange tube.

According to some embodiments of the present disclosure, one eighth water box is defined between the second water box cover plate and the second water box bottom plate.

According to some embodiments of the present disclosure, the one eighth water box is in communication with a second end of at least one corresponding combustion-chamber heat-exchange tube.

According to some embodiments of the present disclosure, one ninth water box is defined between the first water box cover plate and the first water box bottom plate.

According to some embodiments of the present disclosure, the one ninth water box is in communication with a water outlet of the heat exchanger.

According to some embodiments of the present disclosure, the one seventh water box is in communication with the last one of the plurality of fifth water boxes.

According to some embodiments of the present disclosure, liquid in the one seventh water box is configured to flow into the one eighth water box through the corresponding combustion-chamber heat-exchange tube.

According to some embodiments of the present disclosure, the liquid in the eighth water box is then configured to flow into the one ninth water box through the corresponding combustion-chamber heat-exchange tube.

According to some embodiments of the present disclosure, the flue gas flow direction is from top to bottom.

According to some embodiments of the present disclosure, the water inlet is located at a bottom of the heat exchanger.

According to some embodiments of the present disclosure, the water outlet is located at a top of the heat exchanger.

According to some embodiments of the present disclosure, each of the heat-exchange-chamber heat-exchange tubes connected to the fifth water box and the sixth water box has a first end extending through the first water box bottom plate and the first water box cover plate, and a second end extending through the second water box bottom plate and the second water box cover plate.

According to some embodiments of the present disclosure, the first water box bottom plate and the second water box bottom plate are configured as two opposite side walls of the combustion chamber, the heat exchange chamber, and the condensation chamber.

According to some embodiments of the present disclosure, the first water box cover plate and the second water box cover plate are disposed at outer sides of the first water box bottom plate and the second water box bottom plate, respectively.

According to some embodiments of the present disclosure, the third water box cover plate and the third water box bottom plate are located outside the first water box cover plate.

According to some embodiments of the present disclosure, the third water box cover plate and the third water box bottom plate are independent of the first water box cover plate.

According to some embodiments of the present disclosure, the fourth water box cover plate and the fourth water box bottom plate are located outside the second water box cover plate.

According to some embodiments of the present disclosure, the fourth water box cover plate and the fourth water box bottom plate are independent of the second water box cover plate.

According to some embodiments of the present disclosure, the heat-exchange-chamber heat-exchange tubes connected to the fifth water box and the sixth water box are capable of being slightly movable relative to the first water box bottom plate, the first water box cover plate, the second water box bottom plate, and the second water box cover plate.

According to some embodiments of the present disclosure, each of the condensation-chamber heat-exchange tubes and the combustion-chamber heat-exchange tubes is an elliptical tube.

According to some embodiments of the present disclosure, the elliptical tube has a major axis parallel to the flue gas flow direction.

According to some embodiments of the present disclosure, some of the heat-exchange-chamber heat-exchange tubes are circular tubes.

According to some embodiments of the present disclosure, the remaining of the heat-exchange-chamber heat-exchange tubes are elliptical tubes.

According to some embodiments of the present disclosure, each of the elliptical tubes has a major axis parallel to the flue gas flow direction.

According to some embodiments of the present disclosure, a plurality of rows of the heat-exchange-chamber heat-exchange tubes are arranged along the flue gas flow direction.

According to some embodiments of the present disclosure, a number of circular tubes in an upstream row of the heat-exchange-chamber heat-exchange tubes is smaller than a number of circular tubes in an adjacent downstream row of the heat-exchange-chamber heat-exchange tubes.

According to some embodiments of the present disclosure, two tubes located at two ends in the upstream row of the heat-exchange-chamber heat-exchange tubes are the elliptical tubes.

According to some embodiments of the present disclosure, a heat-exchange-chamber fin is arranged around the heat-exchange-chamber heat-exchange tubes.

According to some embodiments of the present disclosure, the heat-exchange-chamber fin has a heat-exchange-chamber fin through hole and a heat-exchange-chamber fin flange surrounding the heat-exchange-chamber fin through hole.

According to some embodiments of the present disclosure, the heat-exchange-chamber heat-exchange tube penetrates through the heat-exchange-chamber fin through hole.

According to some embodiments of the present disclosure, the heat-exchange-chamber heat-exchange tube is fixed to the heat-exchange-chamber fin flange.

According to some embodiments of the present disclosure, the heat-exchange-chamber fin is arranged around the heat-exchange-chamber heat-exchange tubes.

According to some embodiments of the present disclosure, the heat-exchange-chamber fin has a plurality of rows of heat-exchange-chamber fin through holes.

According to some embodiments of the present disclosure, the through holes at a most upstream row of the heat-exchange-chamber fin through holes along the flue gas flow direction at least partially are provided with a heat-exchange-chamber fin surround member surrounding the heat-exchange-chamber fin through holes.

According to some embodiments of the present disclosure, at least one section of the heat-exchange-chamber fin surround member is constructed as a heat-exchange-chamber fin temperature evening section tending to be equal in width.

According to some embodiments of the present disclosure, the heat-exchange-chamber fin temperature evening section is located at a side of the corresponding heat-exchange-chamber fin through hole facing toward the combustion chamber.

According to some embodiments of the present disclosure, the heat-exchange-chamber fin temperature evening section has a central angle of greater than or equal to 45 degrees.

According to some embodiments of the present disclosure, a slit is formed between two adjacent heat-exchange-chamber fin temperature evening sections.

According to some embodiments of the present disclosure, the heat-exchange-chamber fin is arranged around the heat-exchange-chamber heat-exchange tubes.

According to some embodiments of the present disclosure, the heat-exchange-chamber fin has heat-exchange-chamber fin through holes.

According to some embodiments of the present disclosure, the heat-exchange-chamber fin is provided with first heat-exchange flow guide structures.

According to some embodiments of the present disclosure, each first heat-exchange flow guide structure is disposed below corresponding heat-exchange-chamber fin through hole.

According to some embodiments of the present disclosure, a plurality of rows of the heat-exchange-chamber fin through holes are arranged along the flue gas flow direction.

According to some embodiments of the present disclosure, one of the first heat-exchange flow guide structures is positioned above and between each two adjacent heat-exchange-chamber fin through holes that are in a downstream row.

According to some embodiments of the present disclosure, one of the first heat-exchange flow guide structures is also positioned right below one heat-exchange-chamber fin through hole that is in an upstream row.

According to some embodiments of the present disclosure, the heat-exchange-chamber fin is further provided with second heat-exchange flow guide structures.

According to some embodiments of the present disclosure, a plurality of rows of the heat-exchange-chamber fin through holes are arranged along the flue gas flow direction.

According to some embodiments of the present disclosure, one of the second heat-exchange flow guide structures is positioned at one side or two sides of a lower middle part of each heat-exchange-chamber fin through hole in at least one row of the heat-exchange-chamber fin through holes at a downstream side.

According to some embodiments of the present disclosure, one of the second heat-exchange flow guide structures is disposed between two adjacent heat-exchange-chamber fin through holes that are in a same row, to allow the heat-exchange-chamber heat-exchange tubes mounted in the two adjacent heat-exchange-chamber fin through holes to share the second heat-exchange flow guide structure.

According to some embodiments of the present disclosure, each first heat-exchange flow guide structure and each second heat-exchange flow guide structure is configured as an annular flange.

According to some embodiments of the present disclosure, a condensation-chamber fin is disposed around at least some of condensation-chamber heat-exchange tubes, and the condensation-chamber fin has at least one row of condensation-chamber fin through holes.

According to some embodiments of the present disclosure, the condensation-chamber fin is provided with first condensation flow guide structures configured to guide flue gas to the condensation-chamber heat-exchange tubes.

According to some embodiments of the present disclosure, a plurality of rows of the condensation-chamber fin through holes are arranged along the flue gas flow direction.

According to some embodiments of the present disclosure, the first condensation flow guide structures are located at two longitudinal ends of a most upstream row of condensation-chamber fin through holes along the flue gas flow direction.

According to some embodiments of the present disclosure, a pair of first condensation flow guide structures are provided and are disposed obliquely relative to each other.

According to some embodiments of the present disclosure, a distance between the pair of first condensation flow guide structures decreases along the flue gas flow direction to guide flue gas to the condensation-chamber heat-exchange tubes.

According to some embodiments of the present disclosure, the condensation-chamber fin is further provided with second condensation flow guide structures.

According to some embodiments of the present disclosure, one of the second condensation flow guide structures is located at one side or two sides of a lower middle part of each of the condensation-chamber fin through holes.

According to some embodiments of the present disclosure, one of the second condensation flow guide structures is configured to guide flue gas to a lower middle part of the corresponding condensation-chamber heat-exchange tubes.

According to some embodiments of the present disclosure, one of the second condensation flow guide structures is disposed between two adjacent condensation-chamber fin through holes that are in a same row, to allow the condensation-chamber heat-exchange tubes mounted in the two adjacent condensation-chamber fin through holes to share the one second condensation flow guide structure.

According to some embodiments of the present disclosure, each second condensation flow guide structure is configured as a flow guide structure with a narrow top and a wide bottom to allow two side surfaces of the second condensation flow guide structure to form inclined surfaces suitable for guiding flue gas.

According to some embodiments of the present disclosure, the top of the second condensation flow guide structure is located at an upstream side of the bottom of the second condensation flow guide structure along the flue gas flow direction.

According to some embodiments of the present disclosure, a plurality of rows of the condensation-chamber fin through holes are arranged along the flue gas flow direction.

According to some embodiments of the present disclosure, the condensation-chamber fin is further provided with a third condensation flow guide structure between two adjacent rows of the condensation-chamber fin through holes.

According to some embodiments of the present disclosure, the third condensation flow guide structure is configured to guide flue gas from an upstream side to the condensation-chamber heat-exchange tubes at a downstream side.

According to some embodiments of the present disclosure, along the flue gas flow direction, a third condensation flow guide structure is provided above and between each two adjacent condensation-chamber fin through holes that are in a downstream row.

According to some embodiments of the present disclosure, the third condensation flow guide structure is also located right below one condensation-chamber fin through hole in an upstream row.

According to some embodiments of the present disclosure, the third condensation flow guide structure is configured as an annular flange.

According to some embodiments of the present disclosure, a number of rows of the condensation-chamber fin through holes arranged on the condensation-chamber fin is smaller than a number of rows of the condensation-chamber heat-exchange tubes.

According to some embodiments of the present disclosure, at least one row of the condensation-chamber heat-exchange tubes adjacent to an upstream side among the plurality of rows of the condensation-chamber heat-exchange tubes is fit in at least one corresponding row of the condensation-chamber fin through holes.

According to some embodiments of the present disclosure, at least one row of the condensation-chamber heat-exchange tubes located at a downstream side is entirely located at the downstream side of the condensation-chamber fin.

According to some embodiments of the present disclosure, the heat exchanger further includes a heat insulation structure disposed within the combustion chamber.

According to some embodiments of the present disclosure, the heat insulation structure is disposed adjacent to at least a part of a combustion chamber wall of the combustion chamber.

According to some embodiments of the present disclosure, the heat insulation structure includes an insulation layer.

According to some embodiments of the present disclosure, the heat insulation structure has an avoidance portion configured to avoid an ignition member and/or a fire observation window at the housing.

According to some embodiments of the present disclosure, the heat insulation layer is fixed to an inner wall surface of the combustion chamber wall.

According to some embodiments of the present disclosure, the combustion chamber wall is provided with combustion-chamber-wall-flanges.

According to some embodiments of the present disclosure, the combustion-chamber wall flanges are respectively located at two longitudinal ends of the heat insulation layer.

According to some embodiments of the present disclosure, the combustion-chamber wall flanges are configured to fix the heat insulation layer.

According to some embodiments of the present disclosure, the heat exchanger further includes the combustion-chamber heat-exchange tubes provided in the combustion chamber.

According to some embodiments of the present disclosure, the combustion-chamber heat-exchange tubes form a part of the heat insulation structure.

According to some embodiments of the present disclosure, the combustion-chamber heat-exchange tubes are located at a bottom of the heat insulation layer.

According to some embodiments of the present disclosure, the combustion-chamber heat-exchange tubes are configured to insulate heat radiated from flame, which is the flue gas, in the combustion chamber to the combustion chamber wall.

According to some embodiments of the present disclosure, a combustion-chamber fin is arranged around the combustion-chamber heat-exchange tubes.

According to some embodiments of the present disclosure, the combustion-chamber fin is provided with a support flange.

According to some embodiments of the present disclosure, the support flange supports the heat insulation layer.

According to some embodiments of the present disclosure, the heat exchanger further includes the combustion-chamber heat-exchange tubes provided in the combustion chamber.

According to some embodiments of the present disclosure, the combustion-chamber heat-exchange tubes are in communication with the heat-exchange-chamber heat-exchange tubes.

According to some embodiments of the present disclosure, a combustion-chamber fin is arranged around the combustion-chamber heat-exchange tubes.

According to some embodiments of the present disclosure, the combustion-chamber fin has combustion-chamber fin through holes and combustion-chamber fin flanges surrounding the combustion-chamber fin through holes.

According to some embodiments of the present disclosure, the combustion-chamber heat-exchange tubes penetrate through the combustion-chamber fin through holes and are fixed to the combustion-chamber fin flanges.

According to some embodiments of the present disclosure, the combustion-chamber fin is further provided with a combustion-chamber fin edging.

According to some embodiments of the present disclosure, the combustion-chamber fin edging is fixed to the combustion chamber wall.

According to some embodiments of the present disclosure, the combustion-chamber fin has a combustion-chamber fin surround member surrounding each of the combustion-chamber fin through holes.

According to some embodiments of the present disclosure, at least one section of the combustion-chamber fin surround member is configured as a combustion-chamber fin temperature evening section tending to be equal in width.

According to some embodiments of the present disclosure, the housing includes a left side plate assembly, a right side plate assembly, a front side plate assembly, and a rear side plate assembly.

According to some embodiments of the present disclosure, the left side plate assembly, the rear side plate assembly, the right side plate assembly, and the front side plate assembly enclose and are fixed.

According to some embodiments of the present disclosure, a flue gas block structure is provided at a bottom of the housing.

According to some embodiments of the present disclosure, the front side plate assembly includes a front heat insulation plate and a front decorative plate disposed outside the front heat insulation plate.

According to some embodiments of the present disclosure, the front heat insulation plate and the front decorative plate are spaced apart from each other.

According to some embodiments of the present disclosure, the rear side plate assembly includes a rear heat insulation plate and a rear decorative plate disposed outside the rear heat insulation plate.

According to some embodiments of the present disclosure, the rear heat insulation plate and the rear decorative plate are spaced apart from each other.

According to some embodiments of the present disclosure, each of the left side plate assembly and the right side plate assembly is configured as a part of a water box configured to form a water circulation.

A water heater according to another embodiment of the present disclosure includes the above-mentioned heat exchanger.

### BRIEF DESCRIPTION OF DRAWINGS

The above and/or additional aspects and advantages of the present disclosure will become more apparent and more understandable from the following descriptions made with reference to the accompanying drawings.

FIG. 1 is a cross-sectional view of a heat exchanger according to embodiments of the present disclosure.

FIG. 2 is an exploded view of a heat exchanger according to embodiments of the present disclosure.

FIG. 3 is an exploded view of a heat exchanger according to embodiments of the present disclosure.

FIG. 4 is a schematic view showing a structure of a first water box bottom plate or a second water box bottom plate according to embodiments of the present disclosure.

FIG. 5 is a schematic view showing a structure of a first water box cover plate according to embodiments of the present disclosure.

FIG. 6 is a schematic view showing a structure of a second water box cover plate according to embodiments of the present disclosure.

FIG. 7 is a schematic view showing a structure of a third water box bottom plate according to embodiments of the present disclosure.

FIG. 8 is a schematic view showing a structure of a third water box cover plate according to embodiments of the present disclosure.

FIG. 9 is a schematic view showing a structure of a fourth water box bottom plate according to embodiments of the present disclosure.

FIG. 10 is a schematic view showing a structure of a fourth water box cover plate according to embodiments of the present disclosure.

FIG. 11 is a schematic view showing a partial structure of a left side plate assembly according to embodiments of the present disclosure.

FIG. 12 is a schematic view showing a partial structure of a right side plate assembly according to embodiments of the present disclosure.

FIG. 13 is a schematic view showing a partial structure of a left side plate assembly according to embodiments of the present disclosure.

FIG. 14 is a schematic view showing a partial structure of a right side plate assembly according to embodiments of the present disclosure.

FIG. 15 is a cross-sectional view of a heat exchanger according to embodiments of the present disclosure.

FIG. 16 is a schematic view showing a structure of a combustion-chamber fin according to embodiments of the present disclosure.

FIG. 17 is a schematic view showing a structure of a heat-exchange-chamber fin according to embodiments of the present disclosure.

FIG. 18 is a schematic view showing a structure of a heat-exchange-chamber fin according to embodiments of the present disclosure.

FIG. 19 is a schematic view showing a structure of a condensation-chamber fin according to embodiments of the present disclosure.

FIG. 20 is a schematic view showing a structure of a condensation-chamber fin according to embodiments of the present disclosure.

FIG. 21 is an exploded view of a heat exchanger according to embodiments of the present disclosure.

FIG. 22 is a schematic view showing a structure of a front heat insulation plate according to embodiments of the present disclosure.

FIG. 23 is a schematic view showing a structure of a front heat insulation plate according to embodiments of the present disclosure.

FIG. 24 is a schematic view showing a structure of a front heat insulation plate according to embodiments of the present disclosure.

FIG. 25 is a schematic view showing a structure of an insulation layer according to embodiments of the present disclosure.

FIG. 26 is a schematic view showing a structure of a flue gas block structure according to embodiments of the present disclosure.

FIG. 27 is a schematic view showing a structure of a water heater according to embodiments of the present disclosure.

Reference numerals are as follows:
1000, water heater; 100, heat exchanger; 101, ignition member; 102, fire observation window; 10, combustion chamber; 11, heat insulation structure; 111, insulation layer; 1111, insulation layer through hole; 112, combustion-chamber heat-exchange tube;
113, combustion-chamber fin; 1131, support flange; 1132, combustion-chamber fin through hole; 1133, combustion-chamber fin flange; 1134, combustion-chamber fin edging; 1135, combustion-chamber fin surround member;
20, heat exchange chamber; 21, heat-exchange-chamber heat-exchange tube;
22, heat-exchange-chamber fin; 221, heat-exchange-chamber fin through hole; 222, heat-exchange-chamber fin flange; 223, heat-exchange-chamber fin surround member; 224, slit; 225, first heat-exchange flow guide structure; 226, second heat-exchange flow guide structure; 227, third heat-exchange flow guide structure;
30, condensation chamber; 31, condensation-chamber heat-exchange tube;
32, condensation-chamber fin; 321, condensation-chamber fin through hole; 322, first condensation flow guide structure; 323, second condensation flow guide structure; 324, third condensation flow guide structure;
40, housing; 41, left side plate assembly; 411, first water box bottom plate; 412, first water box cover plate; 413, third water box bottom plate; 414, third water box cover plate; 42, right side plate assembly; 421, second water box bottom plate; 422, second water box cover plate; 423, fourth water box bottom plate; 424, fourth water box cover plate; 43, front side plate assembly; 431, front heat insulation plate; 432, front decorative plate; 44, rear side plate assembly; 441, rear heat insulation plate; 442, rear decorative plate; 45, combustion-chamber wall flange; 46, second flange; 47, protrusion structure;
51, first water box; 511, first one of the plurality of first water boxes; 512, second one of the plurality of first water boxes; 513, third one of the plurality of first water boxes; 514, fourth one of the plurality of first water boxes; 515, fifth one of the plurality of first water boxes; 52, second water box; 521, first one of the plurality of second water boxes; 522, second one of the plurality of second water boxes; 523, third one of the plurality of second water boxes; 524, fourth one of the plurality of second water boxes; 525, fifth one of the plurality of second water boxes; 53, third water box; 531, first one of the plurality of third water boxes; 532, second one of the plurality of third water boxes; 54, fourth water box; 541, first one of the plurality of fourth water boxes; 542, second one of the plurality of fourth water boxes; 543, third one of the plurality of fourth water boxes; 55, fifth water box; 551, first one of the plurality of fifth water boxes; 552, second one of the plurality of fifth water boxes; 553, third one of the plurality of fifth water boxes; 554, fourth one of the plurality of fifth water boxes; 56, sixth water box; 561, first one of the plurality of sixth water boxes; 562, second one of the plurality of sixth water boxes; 563, third one of the plurality of sixth water boxes; 57, seventh water box; 58, eighth water box; 59, ninth water box;
60, flue gas block structure; 61, through-hole; 62, flue gas gathering cavity; 63, first flue gas block plate; 64, second flue gas block plate; 65, transition flat plate; 91, water inlet; 92, water outlet;
200, flue gas outlet base; 201, flue gas outlet; 300, air inlet base; 301, air inlet; 400, premixer; 500, fan; 600, combustor; 700, controller; 800, water seal structure; 901, cold water inlet; 900, water inlet pipeline; 1001, gas pipeline; 1002, gas inlet; 1003, hot water outlet; 1004, water proportional valve; 1005, gas proportional valve; 1006, water flow sensor; 1007, hush pipe; 1008, wind pressure transducer.

### DESCRIPTION OF EMBODIMENTS

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

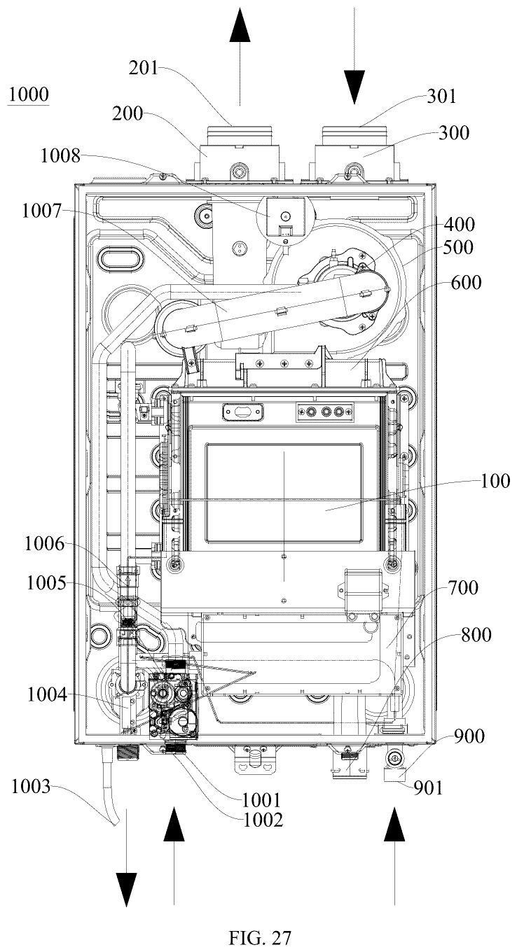

As shown in FIG. 27, a water heater in the embodiments of the present disclosure may be a gas water heater. In the water heater, a heat exchanger is a core component, and water in the water heater will realize heat exchange in the heat exchanger.

A large amount of heat exists in flue gas discharged from a conventional gas water heater. Since the heat in the flue gas cannot be exchanged with water in the heat exchanger, energy cannot be fully utilized, resulting in the energy efficiency of the water heater not being able to reach a high standard and energy being wasted.

To this end, the embodiments of the present disclosure provide a heat exchanger 100 having a condensation heat exchange section, thereby allowing the heat exchanger 100 to have higher heat exchange efficiency and avoiding energy waste caused by a direct discharge of heat from the flue gas. The flue gas further exchanges heat with water in a condensation heat exchange part, and the water heater 1000 is able to reach a higher standard of energy efficiency.

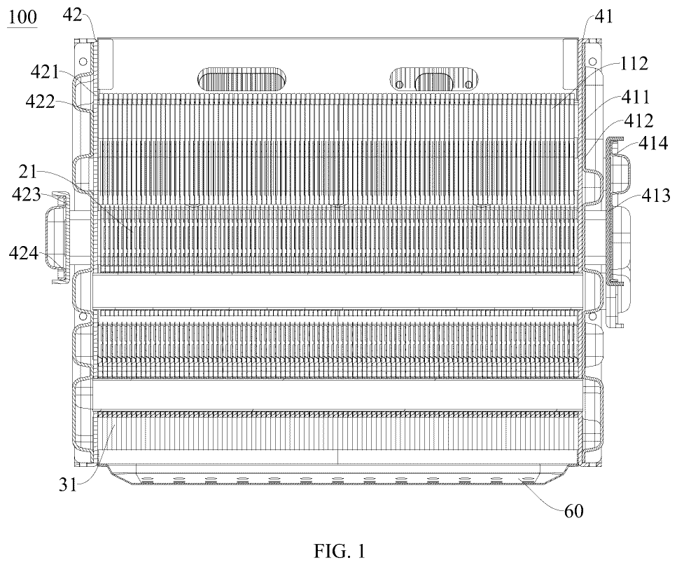

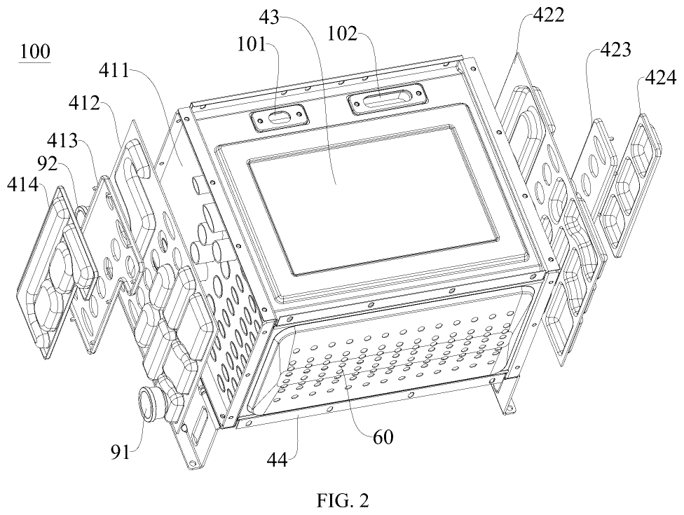

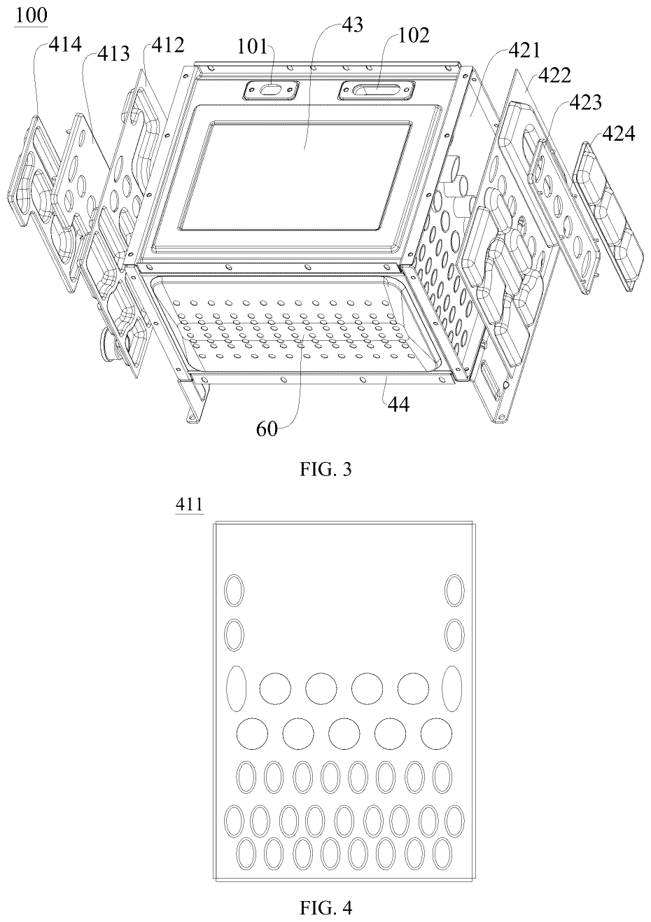

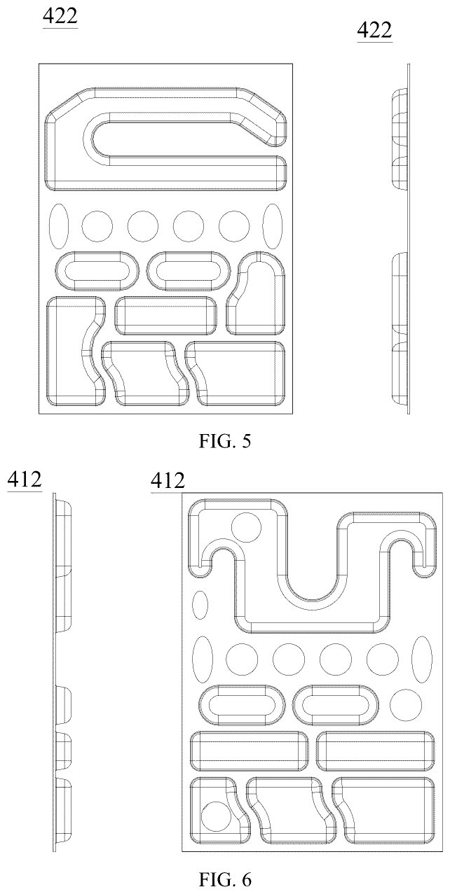

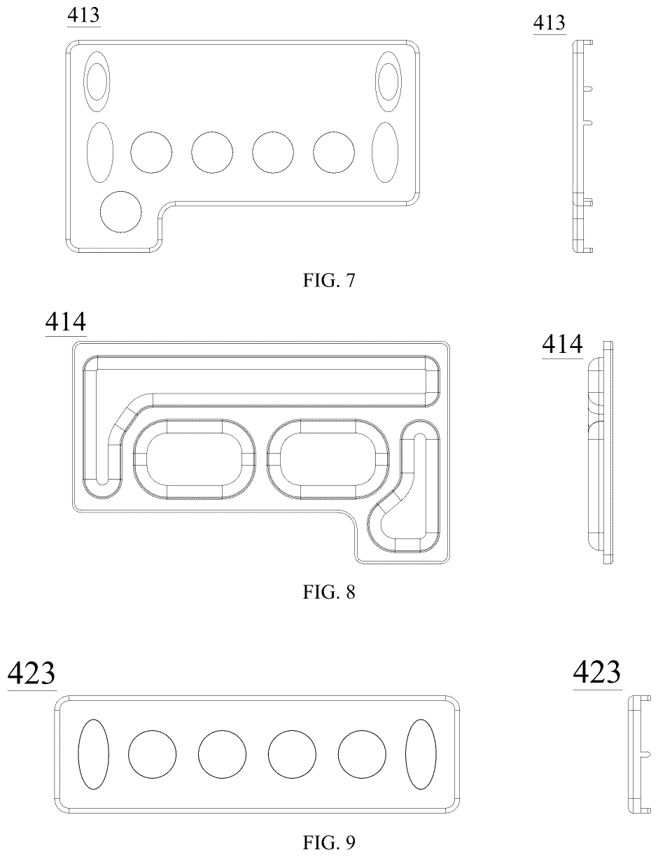

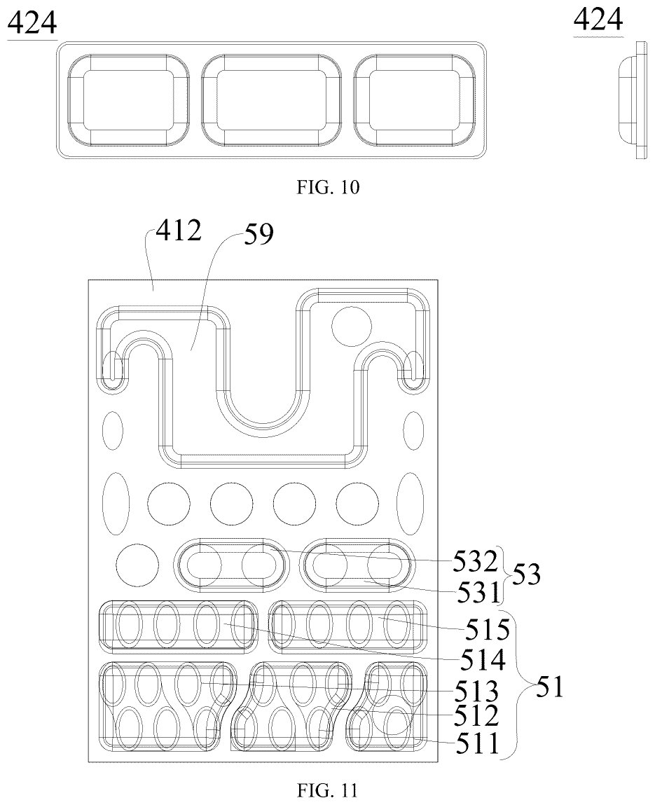

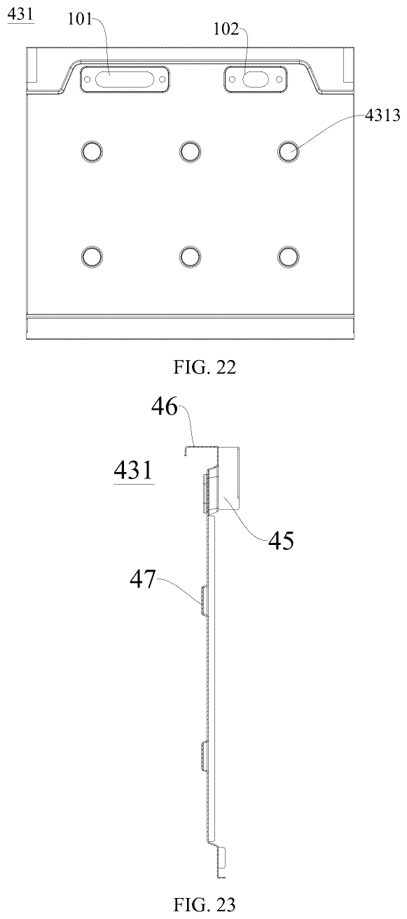

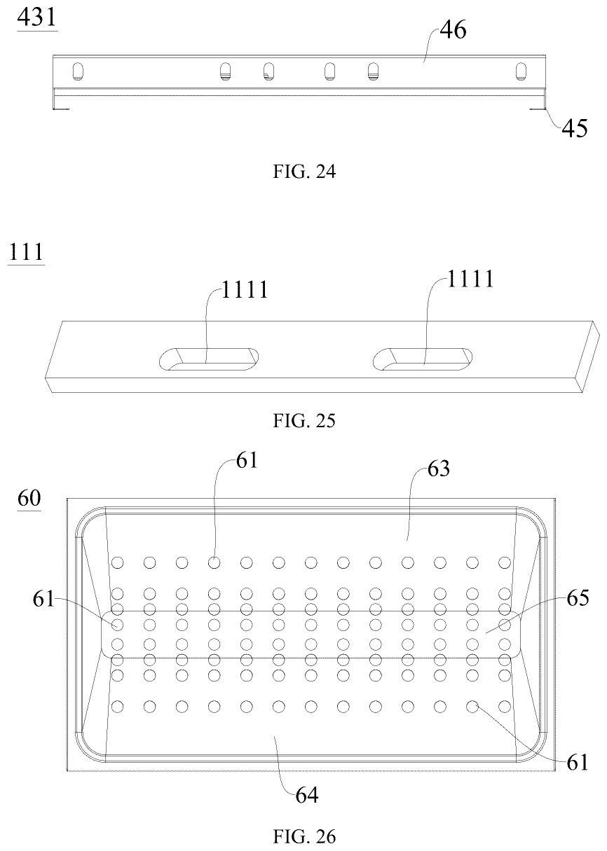

The heat exchanger 100 according to the embodiments of the present disclosure is described below with reference to FIG. 1 to FIG. 27.

The heat exchanger 100 according to the embodiments of the present disclosure may include a housing 40, combustion-chamber heat-exchange tubes 112, condensation-chamber heat-exchange tubes 31, and heat-exchange-chamber heat-exchange tubes 21.

As shown in FIG. 15, the housing 40 internally has a combustion chamber 10, a heat exchange chamber 20, and a condensation chamber 30. The combustion chamber 10, the heat exchange chamber 20, and the condensation chamber 30 are sequentially arranged along a flue gas flow direction within the housing 40, i.e., the flue gas generated through combustion first passes through the combustion chamber 10, then passes through the heat exchange chamber 20 and finally passes through the condensation chamber 30.

The combustion-chamber heat-exchange tubes 112 are provided in the combustion chamber 10. Therefore, the combustion-chamber heat-exchange tubes 112 in the combustion chamber 10 can absorb heat generated by thermal radiation and heat of high-temperature flue gas and exchange heat with water in the combustion-chamber heat-exchange tubes 112. The combustion-chamber heat-exchange tubes 112 are arranged to lower a temperature around the combustion chamber 10, avoiding excessive wall temperature of the heat exchanger 100 causing injury to personnel.

The heat-exchange-chamber heat-exchange tubes 21 are provided in the heat exchange chamber 20. Therefore, the heat-exchange-chamber heat-exchange tubes 21 can absorb heat generated by thermal radiation and heat of high-temperature flue gas in the heat exchange chamber 20 and exchange heat with water in the heat-exchange-chamber heat-exchange tubes 21. The heat-exchange-chamber heat-exchange tubes 21 are arranged to play a main heat exchange function and ensure the heat exchange efficiency of the heat exchanger 100.

The condensation-chamber heat-exchange tubes 31 are provided in the condensation chamber 30. Therefore, the condensation-chamber heat-exchange tubes 31 in the condensation chamber 30 can absorb heat of high-temperature flue gas which passes through the heat exchange chamber 20 and performs heat exchange in the heat exchange chamber 20, and can exchange heat with water in the condensation-chamber heat-exchange tubes 31. An arrangement of the condensation-chamber heat-exchange tubes 31 allows the heat exchanger 100 to have higher heat exchange efficiency, and the energy waste caused by the direct discharge of heat in the flue gas is avoided. The flue gas further exchanges heat with water in the condensation heat exchange part, and the energy efficiency of the water heater 1000 can reach a higher standard.

The heat-exchange-chamber heat-exchange tubes 21 are in communication with the combustion-chamber heat-exchange tubes 112, and the condensation-chamber heat-exchange tubes 31 are in communication with the heat-exchange-chamber heat-exchange tubes 21. That is to say, cold water can sequentially pass through the condensation-chamber heat-exchange tubes 31, the heat-exchange-chamber heat-exchange tubes 21, and the combustion-chamber heat-exchange tubes 112 in the heat exchanger 100, and then output to outside after multistage heat exchange. Therefore, cold water can ensure to be fully heated in the heat exchanger 100, which ensures a heating effect of the heat exchanger 100.

According to the heat exchanger 100 of the embodiments of the present disclosure, the heat exchanger 100 has higher heat exchange efficiency, and the energy waste caused by the direct discharge of heat in the flue gas is avoided. The flue gas further exchanges heat with water in the condensation heat exchange part, and the energy efficiency of the water heater 1000 can reach a higher standard.

As shown in FIG. 11 to FIG. 15, the condensation-chamber heat-exchange tubes 31 are arranged in a plurality of rows along the flue gas flow direction. The condensation-chamber heat-exchange tubes 31 are at least partially divided into a plurality of groups, and each of the plurality of groups includes at least two condensation-chamber heat-exchange tubes 31 arranged in parallel. Therefore, at a part with a lower water temperature, a group of condensation-chamber heat-exchange tubes 31 connected in parallel has a larger cross-sectional area for cold water to pass through, which ensures a sufficient water flow at this part and realizes a large flux heat exchange. Cold water flows through the condensation-chamber heat-exchange tubes 31 faster, to allow a user to obtain a larger amount of hot water faster, and the condensation-chamber heat-exchange tubes 31 connected in parallel can enable sufficient heat exchange between the condensation-chamber heat-exchange tubes 31 and the flue gas in the condensation chamber 30. The heat exchanger 100 has higher thermal efficiency.

In connection with the embodiments shown in FIG. 11 to FIG. 15, at least two condensation-chamber heat-exchange tubes 31 in a same row of the condensation-chamber heat-exchange tubes 31 are connected in parallel. For example, the condensation-chamber heat-exchange tubes 31 in the third row from bottom to top in FIG. 15, in which row condensation-chamber heat-exchange tubes 31 are connected in parallel two by two.

Further, at least two condensation-chamber heat-exchange tubes 31 in a plurality of adjacent rows of the condensation-chamber heat-exchange tubes 31 are connected in parallel, and at least two condensation-chamber heat-exchange tubes 31 connected in parallel are located in at least two adjacent rows. For example, the condensation-chamber heat-exchange tubes 31 in a bottommost row in FIG. 15 is connected in parallel with the condensation-chamber heat-exchange tubes 31 in a second row from bottom to top.

In some embodiments, in a group of parallel condensation-chamber heat-exchange tubes 31, at least two condensation-chamber heat-exchange tubes 31 are in a same row, and at least two condensation-chamber heat-exchange tubes 31 are located in at least two adjacent rows. For example, the condensation-chamber heat-exchange tubes 31 in the bottommost row in FIG. 15 is connected in parallel with the condensation-chamber heat-exchange tubes 31 in the second row from bottom to top. In addition, in the bottommost row from left to right, the first one of the condensation-chamber heat-exchange tubes 31 is connected in parallel with the second one of the condensation-chamber heat-exchange tubes 31, the fourth one of the condensation-chamber heat-exchange tubes 31 is connected in parallel with the fifth one of the condensation-chamber heat-exchange tubes 31, and the seventh one of the condensation-chamber heat-exchange tubes 31 are connected in parallel with the eighth one of the condensation-chamber heat-exchange tubes 31.

Referring to FIG. 11 to FIG. 15, the condensation-chamber heat-exchange tubes 31 are arranged in three rows, to ensure that the flue gas fully exchanges heat in the condensation chamber 30 to reduce an exhaust flue gas temperature, ensuring the heat exchange effect of the heat exchanger 100 and improving the energy efficiency of the water heater 1000.

Two downstream and midstream rows of the condensation-chamber heat-exchange tubes 31 are grouped in a parallel connection along the flue gas flow direction. Each group includes one condensation-chamber heat-exchange tube 31 in the downstream row and one condensation-chamber heat-exchange tube 31 in the midstream row, where a water temperature is low and a water pressure is high. By connecting two adjacent rows of the condensation-chamber heat-exchange tubes 31 in parallel, cold water can fill each of the condensation-chamber heat-exchange tubes 31 while increasing the cross-sectional area for cold water to pass through.

Further, in an upstream row of the condensation-chamber heat-exchange tubes 31, at least two adjacent condensation-chamber heat-exchange tubes 31 in the same row are grouped in a parallel connection. Since the water pressure drops in this row, the condensation-chamber heat-exchange tubes 31 in this row are not connected in parallel with the condensation-chamber heat-exchange tubes 31 in another row. It does not need to transport the water flow to an upper part of the water box against gravity, which prevents the condensation-chamber heat-exchange tubes 31 in the upstream row from breaking due to insufficient water pressure, and prevents the condensation-chamber heat-exchange tubes 31 from burning empty. Therefore, a service life the heat exchanger 100 and use safety of the heat exchanger 100 are ensured.

In some embodiments, referring to FIG. 11 to FIG. 15, the two downstream and midstream rows of the condensation-chamber heat-exchange tubes 31 grouped in a parallel connection include a greater number of condensation-chamber heat-exchange tubes 31 than that of the upstream row of the condensation-chamber heat-exchange tubes 31 grouped in a parallel connection. As water flow temperature increases at the upstream, the flue gas temperature also increases. By reducing the number of condensation-chamber heat-exchange tubes 31 connected in parallel, the cross-sectional area for cold water to pass through can be reduced, and a water flow speed can be increased, to allow the water flow to fully absorb heat, which ensures heat exchange efficiency.

The number of condensation-chamber heat-exchange tubes 31 that are included in the downstream and midstream rows of the condensation-chamber heat-exchange tubes 31 grouped in a parallel connection at two sides is greater than the number of condensation-chamber heat-exchange tubes 31 included in the downstream and midstream rows of condensation-chamber heat-exchange tubes 31 grouped in a parallel connection in the middle. Therefore, the water flow speed in the condensation-chamber heat-exchange tubes 31 in the middle where the flue gas temperature is higher is faster.

In connection with the embodiments shown in FIG. 11 to FIG. 15, the heat-exchange-chamber heat-exchange tubes 21 are arranged in a plurality of rows along the flue gas flow direction. Each of the plurality of rows of the heat-exchange-chamber heat-exchange tubes 21 is arranged in series. In this way, water in the heat-exchange-chamber heat-exchange tubes 21 has a larger flow, and the heat-exchange-chamber heat-exchange tubes 21 have a uniform distribution of water flow and constant flow velocity. The heat exchange effect in the heat-exchange-chamber heat-exchange tubes 21 is better, and a vaporization phenomenon of water flow is avoided to affect the heat exchange effect.

As shown in FIG. 11 to FIG. 15, the combustion-chamber heat-exchange tubes 112 are arranged in a plurality of rows along the flue gas flow direction, and each of the plurality of rows of the combustion-chamber heat-exchange tubes 112 arranged in parallel. Therefore, a water flow in the combustion-chamber heat-exchange tubes 112 connected in parallel in a same row is larger, which avoids the heat exchange efficiency of the heat exchanger 100 affected by the water flow vaporization, and utilizes part of the energy in the combustion chamber 10 to realize a good heat exchange effect of the heat exchanger 100.

Referring to the embodiment shown in FIG. 1 to FIG. 15, the housing 40 includes a first water box bottom plate 411, a second water box bottom plate 421, a first water box cover plate 412, and a second water box cover plate 422. The first water box bottom plate 411 and the first water box cover plate 412 are located at a first end of the heat exchanger 100, and the second water box bottom plate 421 and the second water box cover plate 422 are located at a second end of the heat exchanger 100.

The first water box cover plate 412 covers the first water box bottom plate 411 and defines a plurality of first water boxes 51 with the first water box bottom plate 411. In an exemplary embodiment of the present disclosure, at least a part of the first water box cover plate 412 is connected to the first water box bottom plate 411, and the part divides a space between the first water box cover plate 412 and the first water box bottom plate 411 into a plurality of small spaces. Another part of the first water box cover plate 412 protrudes away from the first water box bottom plate 411, to allow the plurality of the first water boxes 51 to be formed between the first water box cover plate 412 and the first water box bottom plate 411.

In addition, the plurality of the first water boxes 51 are arranged to cover a wall surface of the condensation chamber 30 at a side, which reduces a temperature of the wall surface of the condensation chamber 30 and prevents heat from escaping from the wall surface. Therefore, the heat exchange efficiency of the heat exchanger 100 is increased while avoiding high-temperature burns.

The second water box cover plate 422 covers the second water box bottom plate 421 and defines a plurality of second water boxes 52 with the second water box bottom plate 421. In an exemplary embodiment of the present disclosure, at least a part of the second water box cover plate 422 is connected to the second water box bottom plate 421, and the part divides a space between the second water box cover plate 422 and the second water box bottom plate 421 into a plurality of small spaces. Another part of the second water box cover plate 422 protrudes away from the second water box bottom plate 421. Therefore, the plurality of second water boxes 52 can be formed between the second water box cover plate 422 and the second water box bottom plate 421.

In addition, the plurality of second water boxes 52 are arranged to cover a wall surface of the condensation chamber 30 at another side, which reduces a temperature of the wall surface of the condensation chamber 30 and prevents heat from escaping from the wall surface. Therefore, the heat exchange efficiency of the heat exchanger 100 is increased while avoiding high-temperature burns.

Referring to FIG. 11 to FIG. 15, each of the plurality of first water boxes 51 is in communication with a first end of at least one corresponding condensation-chamber heat-exchange tube 31. Each of the plurality of second water boxes 52 is in communication with a second end of at least one corresponding condensation-chamber heat-exchange tube 31. The first water box 51 and the second water box 52 can not only be in communication with the condensation-chamber heat-exchange tubes 31 connected in parallel, but also two adjacent groups of condensation-chamber heat-exchange tubes 31 connected in parallel can be in communication with each other through the first water box 51 or the second water box 52.

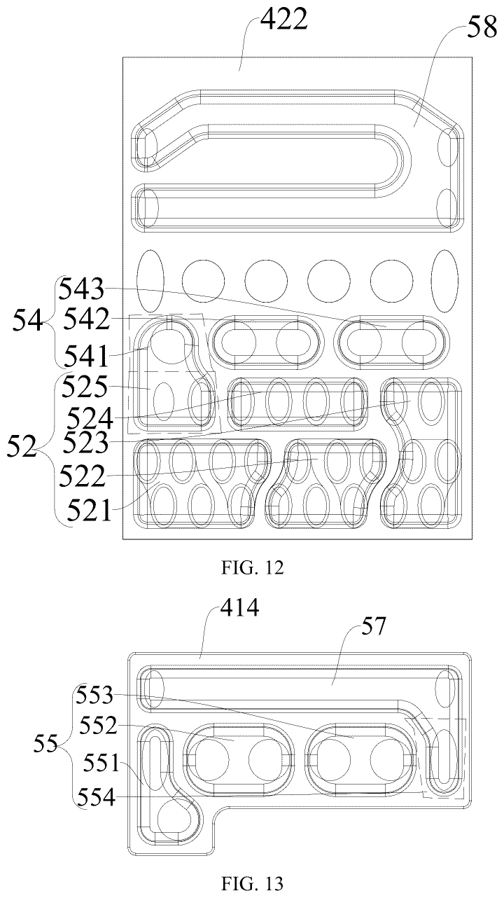

In an exemplary embodiment of the present disclosure, as shown in FIG. 11 and FIG. 12, the first water box 51 that is in communication with a water inlet 91 is in communication with first ends of a first group of the condensation-chamber heat-exchange tubes 31 connected in parallel at the same time that are in communication with the water inlet 91. A first one of the plurality of second water boxes 521 is in communication with second ends of the first group of the condensation-chamber heat-exchange tubes 31 connected in parallel and is also in communication with second ends of a second group of the condensation-chamber heat-exchange tubes 31 connected in parallel. A second one of the plurality of first water boxes 512 is in communication with first ends of the second group of the condensation-chamber heat-exchange tubes 31 connected in parallel and is also in communication with first ends of a third group of the condensation-chamber heat-exchange tubes 31 connected in parallel. Therefore, the condensation-chamber heat-exchange tubes 31 arranged in parallel side by side further form a stable series or parallel water circuit by an arrangement of the plurality of first water boxes 51 and the plurality of second water boxes 52.

In some embodiments, a first one of the plurality of first water boxes 511 is connected to a water inlet 91 of the heat exchanger 100. Liquid in the first one of the plurality of first water boxes 511 flows into a corresponding first one of the plurality of second water boxes 521 through the corresponding condensation-chamber heat-exchange tube 31, and the liquid in the first one of the plurality of second water boxes 521 then flows into a corresponding second one of the plurality of first water boxes 512 through the corresponding condensation-chamber heat-exchange tube 31. The liquid flows in this way until flowing through all the condensation-chamber heat-exchange tubes 31 to a last one of the plurality of second water boxes 52.

In an exemplary embodiment of the present disclosure, referring to FIG. 11 and FIG. 12, the first one of the plurality of first water boxes 511 is connected to the water inlet 91 of the heat exchanger 100. The first water box 51 is further in communication with first ends of two condensation-chamber heat-exchange tubes 31 in a first row from bottom to top and with first ends of two condensation-chamber heat-exchange tubes 31 in a second row from bottom to top. Cold water entering the first water box 51 from the water inlet 91 reaches the second ends of the condensation-chamber heat-exchange tubes 31 after passing through the four condensation-chamber heat-exchange tubes 31.

The first one of the plurality of second water boxes 521 is in communication with second ends of three condensation-chamber heat-exchange tubes 31 in the first row from bottom to top and second ends of four condensation-chamber heat-exchange tubes 31 in the second row from bottom to top. The water flow passes through the two condensation-chamber heat-exchange tubes 31 in the first row and the two condensation-chamber heat-exchange tubes 31 in the second row to reach the first one of the plurality of second water boxes 521, and flows out of the first one of the plurality of second water boxes 521 to the first end through one condensation-chamber heat-exchange tube 31 in the first row and two condensation-chamber heat-exchange tubes 31 in the second row.

The second one of the plurality of first water boxes 512 is in communication with three condensation-chamber heat-exchange tubes 31 in the first row from bottom to top and three condensation-chamber heat-exchange tubes 31 in the second row from bottom to top. The water flow reaches the second one of the plurality of first water boxes 512 through one condensation-chamber heat-exchange tube 31 in the first row and two condensation-chamber heat-exchange tubes 31 in the second row, and then flows out of the second one of the plurality of first water boxes 512 to the second end through two condensation-chamber heat-exchange tubes 31 in the first row and one condensation-chamber heat-exchange tube 31 in the second row.

A second one of the plurality of second water boxes 522 is in communication with three condensation-chamber heat-exchange tubes 31 in the first row from bottom to top and three condensation-chamber heat-exchange tubes 31 in the second row from bottom to top. The water flow reaches the second one of the plurality of second water boxes 522 through two condensation-chamber heat-exchange tubes 31 in the first row and one condensation-chamber heat-exchange tube 31 in the second row, and then flows out of the second one of the plurality of second water boxes 522 to the first end through one condensation-chamber heat-exchange tube 31 in the first row and two condensation-chamber heat-exchange tubes 31 in the second row.

A third one of the plurality of first water boxes 513 is in communication with three condensation-chamber heat-exchange tubes 31 in the first row from bottom to top and four condensation-chamber heat-exchange tubes 31 in the second row from bottom to top. The water flow reaches the third one of the plurality of first water boxes 513 through one condensation-chamber heat-exchange tube 31 in the first row and two condensation-chamber heat-exchange tubes 31 in the second row, and then flows out of the third one of the plurality of first water boxes 513 to the second end through two condensation-chamber heat-exchange tubes 31 in the first row and two condensation-chamber heat-exchange tubes 31 in the second row.

A third one of the plurality of second water boxes 523 is in communication with two

condensation-chamber heat-exchange tubes 31 in the first row from bottom to top, two condensation-chamber heat-exchange tubes 31 in the second row from bottom to top, and two condensation-chamber heat-exchange tubes 31 in a third row from bottom to top. The water flow reaches the third one of the plurality of second water boxes 523 through two condensation-chamber heat-exchange tubes 31 in the first row and two condensation-chamber heat-exchange tubes 31 in the second row, and then flows out of the third one of the plurality of second water boxes 523 to the first end through two condensation-chamber heat-exchange tubes 31 in the third row.

A fourth one of the plurality of first water boxes 514 is in communication with four condensation-chamber heat-exchange tubes 31 in the third row from bottom to top. The water flow reaches the fourth one of the plurality of first water boxes 514 through two condensation-chamber heat-exchange tubes 31 in the third row, and flows out of the fourth one of the plurality of first water boxes 514 to the second end through the other two condensation-chamber heat-exchange tubes 31 in the third row.

A fourth one of the plurality of second water boxes 524 is in communication with four condensation-chamber heat-exchange tubes 31 in the third row from bottom to top. The water flow reaches the fourth one of the plurality of second water boxes 524 through two condensation-chamber heat-exchange tubes 31 in the third row, and flows out of the fourth one of the plurality of second water boxes 524 to the first end through the other two condensation-chamber heat-exchange tubes 31 in the third row.

A fifth one of the plurality of first water boxes 515 is in communication with four condensation-chamber heat-exchange tubes 31 in the third row from bottom to top. The water flow reaches the fifth one of the plurality of first water boxes 515 through two condensation-chamber heat-exchange tubes 31 in the third row, and flows out of the fifth one of the plurality of first water boxes 515 to the second end through the other two condensation-chamber heat-exchange tubes 31 in the third row.

A fifth one of the plurality of second water boxes 525 is the last one of the plurality of second water boxes 52, and is in communication with the second ends of two condensation-chamber heat-exchange tubes 31 in the third row from bottom to top.

Referring to FIG. 11 and FIG. 12, a plurality of third water boxes 53 are defined between the first water box cover plate 412 and the first water box bottom plate 411. In an exemplary embodiment of the present disclosure, at least a part of the first water box cover plate 412 is connected to the first water box bottom plate 411, and the part divides a space between the first water box cover plate 412 and the first water box bottom plate 411 into a plurality of small spaces. Another part of the first water box cover plate 412 protrudes away from the first water box bottom plate 411, to allow the plurality of third water boxes 53 to be formed between the first water box cover plate 412 and the first water box bottom plate 411.

In addition, the plurality of third water boxes 53 are arranged to cover at least a part of a wall surface of the heat exchange chamber 20 at a side, which reduces a temperature of the wall surface of the heat exchange chamber 20 and prevents heat from escaping from the wall surface. Therefore, the heat exchange efficiency of the heat exchanger 100 is increased while avoiding high-temperature burns.

A plurality of fourth water boxes 54 are defined between the second water box cover plate 422 and the second water box bottom plate 421. In an exemplary embodiment of the present disclosure, at least a part of the second water box cover plate 422 is connected to the second water box bottom plate 421, and the part divides a space between the second water box cover plate 422 and the second water box bottom plate 421 into a plurality of small spaces. Another part of the second water box cover plate 422 protrudes away from the second water box bottom plate 421, to allow the plurality of fourth water boxes 54 to be formed between the second water box cover plate 422 and the second water box bottom plate 421.

In addition, the plurality of fourth water boxes 54 are arranged to cover at least a part of a wall surface of the heat exchange chamber 20 at another side, which reduces a temperature of the wall surface of the heat exchange chamber 20 and prevents heat from escaping from the wall surface. Therefore, the heat exchange efficiency of the heat exchanger 100 is increased while avoiding high-temperature burns.

Referring to FIG. 11 and FIG. 12, each of the plurality of third water boxes 53 is in communication with a first end of at least one corresponding heat-exchange-chamber heat-exchange tube 21. Each of the plurality of fourth water boxes 54 is in communication with a second end of at least one corresponding heat-exchange-chamber heat-exchange tube 21. The plurality of third water boxes 53 and the plurality of fourth water boxes 54 are arranged to enable two adjacent heat-exchange-chamber heat-exchange tubes 21 to be in communication with each other, to allow the heat-exchange-chamber heat-exchange tubes 21 to be arranged in series.

The first one of the plurality of fourth water boxes 541 is in communication with the last one of the plurality of second water boxes 52, to enable communication between the heat exchange tubes of the condensation chamber 30 and the heat exchange tubes of the heat exchange chamber 20. In some embodiments, the first one of the plurality of fourth water boxes 541 is the same water box as the last one of the plurality of second water boxes 52.

Further, liquid in the first one of the plurality of fourth water boxes 541 flows into a corresponding first one of the plurality of third water boxes 531 through the corresponding heat-exchange-chamber heat-exchange tube 21. The liquid in the first one of the plurality of third water boxes 531 then flows into a corresponding second one of the plurality of fourth water boxes 542 through the corresponding heat-exchange-chamber heat-exchange tube 21, and the liquid flows in this way until flowing to a last one of the plurality of fourth water boxes 54.

In an exemplary embodiment of the present disclosure, as shown in FIG. 11 and FIG. 12, the first one of the plurality of fourth water boxes 541 is in communication with the last one of the plurality of second water boxes 52, and is in communication with a first one of the heat-exchange-chamber heat-exchange tubes 21 in a fourth row from bottom to top. The water in the last one of the plurality of second water boxes 52 flows directly into the first one of the plurality of fourth water boxes 541 and flows out of the first one of the plurality of fourth water boxes 541 to the first end through the first one of the heat-exchange-chamber heat-exchange tubes 21.

The first one of the plurality of third water boxes 531 is in communication with the first one of the heat-exchange-chamber heat-exchange tubes 21 and a second one of the heat-exchange-chamber heat-exchange tubes 21 in the fourth row from bottom to top. Liquid flows into the first one of the plurality of third water boxes 531 through the first one of the heat-exchange-chamber heat-exchange tubes 21, and flows out of the first one of the plurality of third water boxes 531 to the second end through the second one of the heat-exchange-chamber heat-exchange tubes 21.

The second one of the plurality of fourth water boxes 542 is in communication with the second one of the heat-exchange-chamber heat-exchange tubes 21 and a third one of the heat-exchange-chamber heat-exchange tubes 21 in the fourth row from bottom to top. Liquid flows into the second one of the plurality of fourth water boxes 542 through the second one of the heat-exchange-chamber heat-exchange tubes 21, and flows out of the second one of the plurality of fourth water boxes 542 to the first end through the third one of the heat-exchange-chamber heat-exchange tubes 21.

The second one of the plurality of third water boxes 532 is in communication with the

third one of the heat-exchange-chamber heat-exchange tubes 21 and a fourth one of the heat-exchange-chamber heat-exchange tubes 21 in the fourth row from bottom to top. Liquid flows into the second one of the plurality of third water boxes 532 through the third one of the heat-exchange-chamber heat-exchange tubes 21, and flows out of the second one of the plurality of third water boxes 532 to the second end through the fourth one of the heat-exchange-chamber heat-exchange tubes 21.

A third one of the plurality of fourth water boxes 543 is in communication with the fourth one of the heat-exchange-chamber heat-exchange tubes 21 and a fifth one of the heat-exchange-chamber heat-exchange tubes 21 in the fourth row from bottom to top. Liquid flows into the third one of the plurality of fourth water boxes 543 through the fourth one of the heat-exchange-chamber heat-exchange tubes 21, and flows out of the third one of the plurality of fourth water boxes 543 to the first end through the fifth one of the heat-exchange-chamber heat-exchange tubes 21. The third one of the plurality of fourth water boxes 543 is a last one of the plurality of fourth water boxes 54.

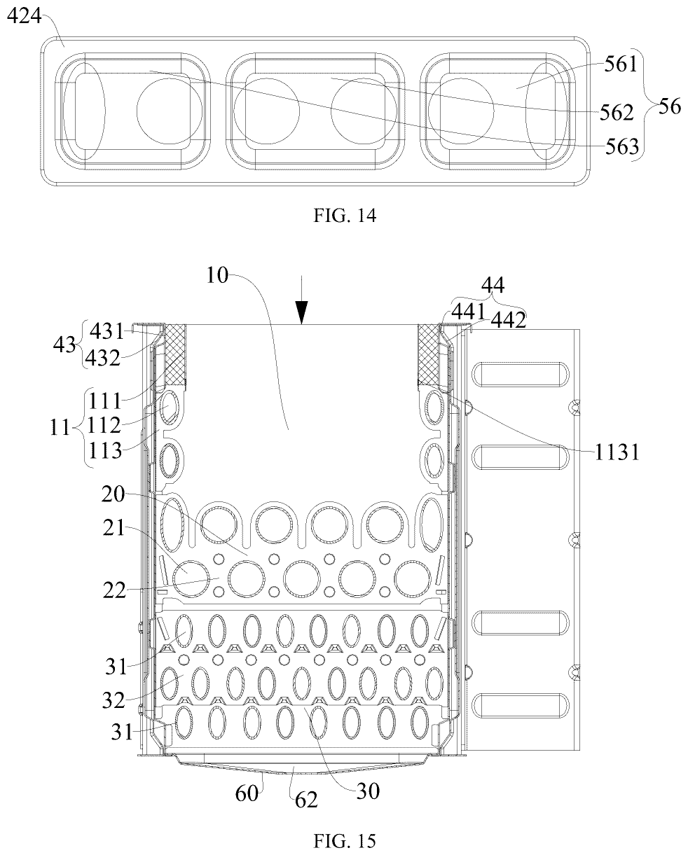

As shown in FIG. 13 and FIG. 14, the heat exchanger 100 further includes a third water box bottom plate 413, a fourth water box bottom plate 423, a third water box cover plate 414, and a fourth water box cover plate 424. The third water box bottom plate 413 and the third water box cover plate 414 are located at the first end of the heat exchanger 100, and the fourth water box bottom plate 423 and the fourth water box cover plate 424 are located at the second end of the heat exchanger 100.

The third water box cover plate 414 covers the third water box bottom plate 413 and defines a plurality of fifth water boxes 55 with the third water box bottom plate 413. In an exemplary embodiment of the present disclosure, at least a part of the third water box cover plate 414 is connected to the third water box bottom plate 413. This part divides a space between the third water box cover plate 414 and the third water box bottom plate 413 into a plurality of small spaces. Another part of the third water box cover plate 414 protrudes away from the third water box bottom plate 413, to allow the plurality of fifth water boxes 55 to be formed between the third water box cover plate 414 and the third water box bottom plate 413.

In addition, the plurality of fifth water boxes 55 are arranged to cover a wall surface of the heat exchange chamber 20 at a side, which reduces a temperature of the wall surface of the heat exchange chamber 20 and prevents heat from escaping from the wall surface. Therefore, the heat exchange efficiency of the heat exchanger 100 is increased while avoiding high-temperature burns.

The fourth water box cover plate 424 covers the fourth water box bottom plate 423 and defines a plurality of sixth water boxes 56 with the fourth water box bottom plate 423. In an exemplary embodiment of the present disclosure, at least a part of the fourth water box cover plate 424 is connected to the fourth water box bottom plate 423. This part divides a space between the fourth water box cover plate 424 and the fourth water box bottom plate 423 into a plurality of small spaces. Another part of the fourth water box cover plate 424 protrudes away from the fourth water box bottom plate 423, to allow the plurality of sixth water boxes 56 to be formed between the fourth water box cover plate 424 and the fourth water box bottom plate 423.

In addition, the plurality of sixth water boxes 56 are arranged to cover a wall surface of the heat exchange chamber 20 at another side, which reduces a temperature of the wall surface of the heat exchange chamber 20 and prevents heat from escaping from the wall surface. Therefore, the heat exchange efficiency of the heat exchanger 100 is increased while avoiding high-temperature burns.

Referring to FIG. 11 to FIG. 15, each of the plurality of fifth water boxes 55 is in communication with a first end of at least one corresponding heat-exchange-chamber heat-exchange tube 21. Each of the plurality of sixth water boxes 56 is in communication with a second end of at least one corresponding heat-exchange-chamber heat-exchange tube 21. The plurality of fifth water boxes 55 and the plurality of sixth water boxes 56 are capable of enabling two adjacent heat-exchange-chamber heat-exchange tubes 21 to be in communication with each other.

At least one heat-exchange-chamber heat-exchange tube 21 is connected between a first one of the plurality of fifth water boxes 551 and a last one of the plurality of fourth water boxes 54. Liquid in the first one of the plurality of fifth water boxes 551 flows into a corresponding first one of the plurality of sixth water boxes 561 through the corresponding heat-exchange-chamber heat-exchange tube 21. The liquid in the first one of the plurality of sixth water boxes 561 then flows into a corresponding second one of the plurality of fifth water boxes 552 through the corresponding heat-exchange-chamber heat-exchange tube 21, and the liquid flows in this way until flowing to a last one of the plurality of fifth water boxes 55.

In an exemplary embodiment of the present disclosure, as shown in FIG. 13 and FIG. 14, the first one of the plurality of fifth water boxes 551 is in communication with the last one of the plurality of fourth water boxes 54 through a fifth one of the heat-exchange-chamber heat-exchange tubes 21 in the fourth row from bottom to top, and is in communication with a sixth one of the heat-exchange-chamber heat-exchange tubes 21 in a fifth row from bottom to top. The water in the last one of the plurality of fourth water boxes 54 flows into the first one of the plurality of fifth water boxes 551 through the fifth one of the heat-exchange-chamber heat-exchange tubes 21 in the fourth row from bottom to top, and flows out of the first one of the plurality of fifth water boxes 551 to the second end through the sixth one of the heat-exchange-chamber heat-exchange tubes 21 in the fifth row from the bottom.

The first one of the plurality of sixth water boxes 561 is in communication with the sixth one of heat-exchange-chamber heat-exchange tubes 21 and a seventh one of the heat-exchange-chamber heat-exchange tubes 21 in the fifth row from bottom to top. Liquid flows into the first one of the plurality of sixth water boxes 561 through the fifth one of the heat-exchange-chamber heat-exchange tubes 21, and flows out of the first one of the plurality of sixth water boxes 561 to the first end through the seventh one of the heat-exchange-chamber heat-exchange tubes 21.

The second one of the plurality of fifth water boxes 552 is in communication with the seventh one of the heat-exchange-chamber heat-exchange tubes 21 and an eighth one of the heat-exchange-chamber heat-exchange tubes 21 in the fifth row from bottom to top. Liquid flows into the second one of the plurality of fifth water boxes 552 through the seventh one of the heat-exchange-chamber heat-exchange tubes 21, and flows out of the second one of the plurality of fifth water boxes 552 to the second end through the eighth one of the heat-exchange-chamber heat-exchange tubes 21.

A second one of the plurality of sixth water boxes 562 is in communication with the eighth one of the heat-exchange-chamber heat-exchange tubes 21 and a ninth one of the heat-exchange-chamber heat-exchange tubes 21 in the fifth row from bottom to top. Liquid flows into the second one of the plurality of sixth water boxes 562 through the eighth one of the heat-exchange-chamber heat-exchange tubes 21, and flows out of the second one of the plurality of sixth water boxes 562 to the first end through the ninth one of the heat-exchange-chamber heat-exchange tubes 21.

A third one of the plurality of fifth water boxes 553 is in communication with the ninth one of the heat-exchange-chamber heat-exchange tubes 21 and a tenth one of the heat-exchange-chamber heat-exchange tubes 21 in the fifth row from bottom to top. Liquid flows into the third one of the plurality of fifth water boxes 553 through the ninth one of the heat-exchange-chamber heat-exchange tubes 21, and flows out of the third one of the plurality of fifth water boxes 553 to the second end through the tenth one of the heat-exchange-chamber heat-exchange tubes 21.

A third one of the plurality of sixth water boxes 563 is in communication with the tenth one of the heat-exchange-chamber heat-exchange tubes 21 and an eleventh one of the heat-exchange-chamber heat-exchange tubes 21 in the fifth row from bottom to top. Liquid flows into the third one of the plurality of sixth water boxes 563 through the tenth one of the heat-exchange-chamber heat-exchange tubes 21, and flows out of the third one of the plurality of sixth water boxes 563 to the first end through the eleventh one of the heat-exchange-chamber heat-exchange tubes 21.

A fourth one of the plurality of fifth water boxes 554 is in communication with the eleventh one of the heat-exchange-chamber heat-exchange tubes 21 from bottom to top, and liquid flows into the fourth one of the plurality of fifth water boxes 554 through the eleventh one of the heat-exchange-chamber heat-exchange tubes 21. The fourth one of the plurality of fifth water boxes 554 is the last one of the plurality of fifth water boxes 55.

Referring to FIG. 13 and FIG. 14, one seventh water box 57 is defined between the third water box cover plate 414 and the third water box bottom plate 413. In an exemplary embodiment of the present disclosure, at least a part of the third water box cover plate 414 is connected to the third water box bottom plate 413, and divides a space between the third water box cover plate 414 and the third water box bottom plate 413 into a plurality of small spaces. Another part of the third water box cover plate 414 protrudes away from the third water box bottom plate 413, to allow the one seventh water box 57 to be formed between the third water box cover plate 414 and the third water box bottom plate 413.

In addition, the seventh water box 57 is arranged to cover at least a part of a wall surface of the combustion chamber 10 at a side, which reduces a temperature of the wall surface of the combustion chamber 10 and prevents heat from escaping from the wall surface. Therefore, the heat exchange efficiency of the heat exchanger 100 is increased while avoiding high-temperature burns.

One eighth water box 58 is defined between the second water box cover plate 422 and the second water box bottom plate 421. In an exemplary embodiment of the present disclosure, at least a part of the second water box cover plate 422 is connected to the second water box bottom plate 421 and divides a space between the second water box cover plate 422 and the second water box bottom plate 421 into a plurality of small spaces. Another part of the second water box cover plate 422 protrudes away from the second water box bottom plate 421, to allow the one eighth water box 58 to be formed between the second water box cover plate 422 and the second water box bottom plate 421.

In addition, the eighth water box 58 is arranged to cover at least a part of the wall surface of the combustion chamber at a side, which reduces a temperature of the wall surface of the combustion chamber 10 and prevents heat from escaping from the wall surface. Therefore, the heat exchange efficiency of the heat exchanger 100 is increased while avoiding high-temperature burns.

One ninth water box 59 is defined between the first water box cover plate 412 and the first water box bottom plate 411. In an exemplary embodiment of the present disclosure, at least a part of the first water box cover plate 412 is connected to the first water box bottom plate 411 and divides a space between the first water box cover plate 412 and the first water box bottom plate 411 into a plurality of small spaces. Another part of the first water box cover plate 412 protrudes away from the first water box bottom plate 411, to allow the one ninth water box 59 to be formed between the first water box cover plate 412 and the first water box bottom plate 411.

In addition, the ninth water box 59 is arranged to cover at least a part of the wall surface of the combustion chamber 10 at a side, which reduces a temperature of the wall surface of the combustion chamber 10 and prevents heat from escaping from the wall surface. Therefore, the heat exchange efficiency of the heat exchanger 100 is increased while avoiding high-temperature burns.

The seventh water box 57 is in communication with a first end of at least one corresponding combustion-chamber heat-exchange tube 112, to allow the at least one combustion-chamber heat-exchange tube 112 to be connected in parallel. The seventh water box 57 is in communication with the last one of the plurality of fifth water boxes 55. Therefore, the liquid in the last one of the plurality of fifth water boxes 55 can flow directly into the seventh water box 57 and into the second end through the combustion-chamber heat-exchange tubes 112 in communication with the seventh water box 57.

The eighth water box 58 is in communication with a second end of at least one corresponding combustion-chamber heat-exchange tube 112, to allow liquid flowing from the first end to the second end to be back to the first end through the eighth water box 58.

The ninth water box 59 is in communication with a water outlet 92 of the heat exchanger 100. Liquid in the seventh water box 57 flows into the eighth water box 58 through the corresponding combustion-chamber heat-exchange tube 112, and the liquid in the eighth water box 58 then flows into the ninth water box 59 through the corresponding combustion-chamber heat-exchange tube 112.

In an exemplary embodiment of the present disclosure, as shown in FIG. 11 and FIG. 14, the seventh water box 57 is in communication with the last one of the plurality of fifth water boxes 55. Therefore, liquid in the last one of the plurality of fifth water boxes 55 can flow directly into the seventh water box 57 and into the second end through the combustion-chamber heat-exchange tubes 112 in communication with the seventh water box 57.

The seventh water box 57 is in communication with two combustion-chamber heatexchange tubes 112 in a second row from top to bottom, and the liquid in the seventh water box 57 can flow into the second end through the two combustion-chamber heat-exchange tubes 112 in the second row from top to bottom.

The eighth water box 58 is in communication with two combustion-chamber heat-exchange tubes 112 in the second row from top to bottom and two combustion-chamber heat-exchange tubes 112 in a first row from top to bottom at the same time. Liquid flows into the eighth water box 58 through two combustion-chamber heat-exchange tubes 112 in the second row from top to bottom and then flows into the first end through the two combustion-chamber heat-exchange tubes 112 in the first row from top to bottom.

The ninth water box 59 is in communication with two combustion-chamber heat-exchange tubes 112 in the first row from top to bottom and further in communication with the water outlet 92 of the heat exchanger 100. Liquid flows into the ninth water box 59 through two combustion-chamber heat-exchange tubes 112 in the first row from top to bottom and flows out of heat exchange tubes of the heat exchanger 100 through the water outlet 92.

Referring to FIG. 15, the arrow in the figure indicates the flue gas flow direction. In some embodiments, the flue gas flow direction is from top to bottom. The water inlet 91 is located at a bottom of the heat exchanger 100, and the water outlet 92 is located at a top of the heat exchanger 100. Therefore, a temperature of water increases gradually from bottom to top, and a temperature of a space inside the heat exchanger 100 decreases from top to bottom, thereby ensuring that there is a sufficient temperature difference between the liquid and the temperature of the space inside the heat exchanger 100 for heat exchange, and ensuring the heat exchange efficiency.

In other embodiments, the flue gas flow direction may be from bottom to top, or the flue gas first flows from top to bottom and then flows from bottom to top. The flue gas flow direction, i.e., an arrangement of flue gas flow channels in the heat exchanger 100, is not limited herein.

As shown in FIG. 1 to FIG. 3, each of the heat-exchange-chamber heat-exchange tubes 21 connected to the fifth water box 55 and the sixth water box 56 has a first end extending through the first water box bottom plate 411 and the first water box cover plate 412 and a second end extending through the second water box bottom plate 421 and the second water box cover plate 422. Therefore, the heat-exchange-chamber heat-exchange tubes 21 can be in communication with the fifth water box 55 located outside the first water box bottom plate 411 and the first water box cover plate 412, and the sixth water box 56 located outside the second water box bottom plate 421 and the second water box cover plate 422.

In some embodiments, referring to FIG. 1 to FIG. 3, each of the combustion-chamber heat-exchange tubes 112 connected to the seventh water box 57 has a first end extending through the first water box bottom plate 411 and the first water box cover plate 412, to allow the combustion-chamber heat-exchange tubes 112 to be in communication with the seventh water box 57 located outside the first water box bottom plate 411 and the second water box cover plate 422.

As shown in FIG. 1 to FIG. 3, the first water box bottom plate 411 and the second water box bottom plate 421 are configured as two opposite side walls of the combustion chamber 10, the heat exchange chamber 20, and the condensation chamber 30. The first water box cover plate 412 and the second water box cover plate 422 are disposed at outer sides of the first water box bottom plate 411 and the second water box bottom plate 421, respectively. Therefore, the first water box bottom plate 411 and the second water box cover plate 422 are capable of forming a heat exchanger water circuit of the heat exchanger 100 outside side walls of the heat exchanger 100.

The third water box cover plate 414 and the third water box bottom plate 413 are located outside and independent of the first water box cover plate 412. Therefore, the third water box cover plate 414 and the third water box bottom plate 413 can move relative to the first water box cover plate 412. The fourth water box cover plate 424 and the fourth water box bottom plate 423 are located outside and independent of the second water box cover plate 422. Therefore, the fourth water box bottom plate 423 and the fourth water box cover plate 424 can move relative to the second water box cover plate 422.

Each of the fifth water box 55 and the sixth water box 56 has a relatively highwater temperature. By arranging the fifth water box 55 and the sixth water box 56 separately from the heat exchange chamber 20, thermal stress can be avoided between the high-temperature flue gas in the heat exchange chamber 20 and the high-temperature liquid in the fifth water box 55 and the sixth water box 56.

According to some embodiments of the present disclosure, the heat-exchange-chamber heat-exchange tubes 21 connected to the fifth water box 55 and the sixth water box 56 are capable of being slightly movable relative to the first water box bottom plate 411, the first water box cover plate 412, the second water box bottom plate 421, and the second water box cover plate 422.

Since the temperature of the liquid in the heat-exchange-chamber heat-exchange tubes 21 connected to the fifth water box 55 and the sixth water box 56 is relatively high, and the temperature of the high-temperature flue gas in an environment in which these heat-exchange-chamber heat-exchange tubes 21 are located is also relatively high, thermal stress is generated between the heat-exchange-chamber heat-exchange tubes 21 and the high-temperature flue gas in the heat exchange chamber 20. In addition, the heat-exchange-chamber heat-exchange tubes 21 are deformed and slightly displaced. The heat-exchange-chamber heat-exchange tubes 21 are capable of being slightly movable relative to the first water box bottom plate 411, the first water box cover plate 412, the second water box bottom plate 421, and the second water box cover plate 422, preventing the heat-exchange-chamber heat-exchange tubes 21 from being broken due to stress, and prolonging the service life of the heat exchanger 100.

As shown in FIG. 15, each of the condensation-chamber heat-exchange tubes 31 and the combustion-chamber heat-exchange tubes 112 is an elliptical tube. The elliptical tube has a major axis parallel to the flue gas flow direction. The elliptical tube has a larger surface area, which increases a heat exchange area. Since the major axis of the elliptical tube is parallel to the flue gas flow direction, the heat exchange area of the elliptical tube with the flue gas is larger along the flue gas flow direction, which improves the heat exchange efficiency of the heat exchanger 100. Moreover, since a minor axis of the elliptical tube is perpendicular to the flue gas flow direction, more heat exchange tubes can be arranged in the heat exchanger 100 with a same width, thereby improving the heat exchange efficiency of the heat exchanger 100 and reducing an overall volume of the heat exchanger 100.

Referring to FIG. 15, some of the heat-exchange-chamber heat-exchange tubes 21 are circular tubes, and resistance of the circular tubes is relatively small. Therefore, the water flow velocity in the heat-exchange-chamber heat-exchange tubes 21 can be maintained at a relatively high rate, and insoluble matters are prevented from depositing in the heat-exchange-chamber heat-exchange tubes 21, avoiding scale causing localized high-temperature fatigue fractures within heat-exchange-chamber heat-exchange tubes 21 and avoiding deteriorating operation conditions. The service life of heat exchanger 100 is prolonged.

Additionally, the remaining of the heat-exchange-chamber heat-exchange tubes 21 are elliptical tubes, to facilitate an arrangement of the heat-exchange-chamber heat-exchange tubes 21. In this way, more heat-exchange-chamber heat-exchange tubes 21 can be arranged in a smaller space, which improves the heat exchange efficiency, and a surface area of the elliptical tube is larger, which increases the heat exchange area. Since the major axis of the elliptical tubes is parallel to the flue gas flow direction, the heat exchange area of the elliptical tubes with the flue gas is larger along the flue gas flow direction, which improves the heat exchange efficiency of heat exchanger 100.

As shown in FIG. 15, the heat-exchange-chamber heat-exchange tubes 21 are arranged in a plurality of rows along the flue gas flow direction. A number of circular tubes in an upstream row of the heat-exchange-chamber heat-exchange tubes 21 is smaller than a number of circular tubes in an adjacent downstream row of the heat-exchange-chamber heat-exchange tubes 21, and two tubes located at two ends in the upstream row of the heat-exchange-chamber heat-exchange tubes 21 are the elliptical tubes.

In an exemplary embodiment of the present disclosure, as shown in FIG. 15, the heat-exchange-chamber heat-exchange tubes 21 are arranged in two rows. The upstream row of the heat-exchange-chamber heat-exchange tubes 21 has four circular tubes located at the middle, and two elliptical tubes at the two ends. The downstream row of the heat-exchange-chamber heat-exchange tubes 21 has five circular tubes. Any circular tube at the upstream side is located corresponding to the middle of two adjacent circular tubes at the downstream side.

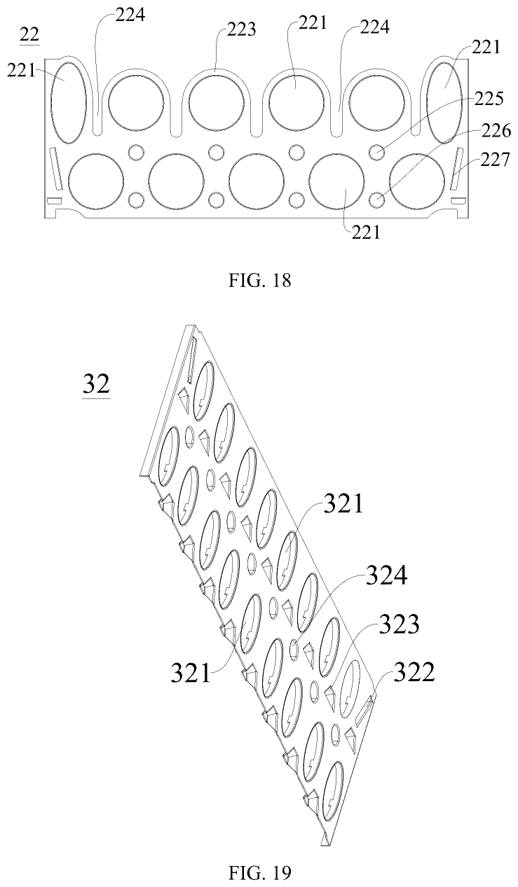

In conjunction with embodiments shown in FIG. 15, FIG. 17, and FIG. 18, a heat-exchange-chamber fin 22 is arranged around each of the heat-exchange-chamber heat-exchange tubes 21. The heat-exchange-chamber fin 22 has heat-exchange-chamber fin through holes 221 and heat-exchange-chamber fin flanges 222 surrounding the heat-exchange-chamber fin through holes 221. The heat-exchange-chamber heat-exchange tube 21 penetrates through the heat-exchange-chamber fin through hole 221 and is fixed to the heat-exchange-chamber fin flange 222, to ensure mounting stability of the heat-exchange-chamber heat-exchange tube 21 to the heat-exchange-chamber fin 22.

Consequently, the heat-exchange-chamber heat-exchange tubes 21 and the heat-exchange-chamber fin 22 together form a tube-fin structure for convective heat exchange with the flue gas, ensuring that the heat-exchange-chamber heat-exchange tubes 21 have sufficient contact area with the flue gas to improve the heat exchange efficiency.

Further, since the heat-exchange-chamber fin 22 is connected to all heat-exchange-chamber heat-exchange tubes 21 at the same time, thereby ensuring that respective heat-exchange-chamber heat-exchange tubes 21 have an even temperature, further improving the heat-exchange efficiency.

In some embodiments, a cross-sectional area of heat-exchange-chamber heat-exchange tube 21 is greater than a cross-sectional area of the combustion-chamber heat-exchange tube 112 and a cross-sectional area of condensation-chamber heat-exchange tube 31.

As shown in FIG. 15, FIG. 17, and FIG. 18, the heat-exchange-chamber fin 22 is arranged around the heat-exchange-chamber heat-exchange tubes 21, and the heat-exchange-chamber fin 22 has a plurality of rows of heat-exchange-chamber fin through holes 221. The through holes 61 at a most upstream row of the heat-exchange-chamber fin through holes 221 along the flue gas flow direction at least partially are provided with heat-exchange-chamber fin surround members 223 surrounding the heat-exchange-chamber fin through holes 221. At least one section of the heat-exchange-chamber fin surround member 223 is constructed as a temperature evening section of the heat-exchange-chamber fin 22 tending to be equal in width. As a result, a size between a tube wall of the heat-exchange-chamber heat-exchange tubes 21 corresponding to the heat-exchange-chamber fin through holes 221 corresponding to this section and an edge of the heat-exchange-chamber fin 22 is uniform. The tube wall of the corresponding heat-exchange-chamber heat-exchange tubes 21 has uniform distributed temperature in all directions, allowing the tube wall of the heat-exchange-chamber heat-exchange tube 21 to exchange heat evenly. In this way, uneven temperatures can be avoided to have an impact on the service life of the heat-exchange-chamber fin 22 and the service life of the heat-exchange-chamber heat-exchange tube 21.

Referring to FIG. 15, FIG. 17, and FIG. 18, the temperature evening section of the heat-exchange-chamber fin 22 is located at a side of the corresponding heat-exchange-chamber fin through hole 221 facing toward the combustion chamber 10. A temperature of the high-temperature flue gas received by the temperature evening section is relatively high, and the heat exchange between the high-temperature flue gas and the heat-exchange-chamber heat-exchange tube 21 has a great influence on the service life of the heat-exchange-chamber heat-exchange tube 21. By designing the corresponding temperature evening section of the heat-exchange-chamber fin 22, temperature may be evened at this place, avoiding uneven temperature on the heat-exchange-chamber fin 22 and the service life of the heat-exchange-chamber heat-exchange tube 21.

In conjunction with the embodiments shown in FIG. 15, FIG. 17, and FIG. 18, the temperature evening section of the heat-exchange-chamber fin 22 has a central angle of greater than or equal to 45 degrees, to ensure that the heat-exchange-chamber fin 22 and the heat-exchange-chamber heat-exchange tubes 21 have an area large enough to maintain even temperature and to ensure the service life of the heat-exchange-chamber fin 22 and the service life of the heat-exchange-chamber heat-exchange tube 21.

Referring to FIG. 15, FIG. 17, and FIG. 18, a slit 224 is formed between two adjacent temperature evening sections of the heat-exchange-chamber fin 22. Therefore, by reducing a contact area between the heat-exchange-chamber fin 22 and the high-temperature flue gas through the slit 224, the temperature of the heat-exchange-chamber heat-exchange tube 21 is prevented from becoming too high, to ensure the service life of the heat-exchange-chamber heat-exchange tube 21. In addition, at least one section of the heat-exchange-chamber fin surround member 223 is constructed to tend to be equal in width through the slit 224.

As shown in FIG. 15, FIG. 17, and FIG. 18, the heat-exchange-chamber fin 22 is arranged around the heat-exchange-chamber heat-exchange tubes 21. The heat-exchange-chamber fin 22 has heat-exchange-chamber fin through holes 221 and is provided with first heat-exchange flow guide structures 225. The flue gas can uniformly flow around heat-exchange-chamber heat-exchange tubes 21 through the first heat-exchange flow guide structures 225, avoiding dead corners in a flue gas flow process which affects the heat exchange efficiency of the heat exchanger 100.

In conjunction with that embodiment shown in FIG. 15, FIG. 17, and FIG. 18, the first heat-exchange flow guide structure 225 is disposed below corresponding heat-exchange-chamber fin through hole 221. In an exemplary embodiment of the present disclosure, after passing through and exchanging heat with the upstream row of heat-exchange-chamber heat-exchange tubes 21, the flue gas converges below the heat-exchange-chamber heat-exchange tubes 21, i.e., converges above the first-heat-exchange flow guide structures 225. If the flue gas is not guided at this time, the flue gas will flow downward directly through slots of the downstream row of heat-exchange-chamber heat-exchange tubes 21, reducing the heat exchange efficiency. Therefore, the first heat-exchange flow guide structure 225 is provided below the corresponding heat-exchange-chamber fin through hole 221, which can guide the flue gas to a lower part of the upstream row of heat-exchange-chamber heat-exchange tubes 21 and an upper part of the downstream row of heat-exchange-chamber heat-exchange tubes 21. In this way, the lower part of the upstream row of heat-exchange-chamber heat-exchange tubes 21 and the upper part of the downstream row of heat-exchange-chamber heat-exchange tubes 21 can be fully contacted with the flue gas, allowing the heat exchange efficiency to be improved.

Referring to FIG. 15, FIG. 17, and FIG. 18, the heat-exchange-chamber fin through holes 221 are arranged in a plurality of rows along the flue gas flow direction. One first heat-exchange flow guide structure 225 is disposed above and between each two adjacent heat-exchange-chamber fin through holes 61 that are in a downstream row. In this way, the flue gas converged above the first heat-exchange flow guide structure 225 can be uniformly guided to the upper part of the downstream row of the heat-exchange-chamber heat-exchange tubes 21 located at two sides of the first heat-exchange flow guide structure 225.

In addition, the first heat-exchange flow guide structure 225 is further located directly below a corresponding heat-exchange-chamber fin through hole 221 in an upstream row, to ensure that one heat-exchange-chamber heat-exchange tube 21 at the upstream side has a corresponding first heat-exchange flow guide structure 225 which guides the flue gas to the lower part of the heat-exchange-chamber heat-exchange tube 21.

As shown in FIG. 15, FIG. 17, and FIG. 18, the heat-exchange-chamber fin 22 is further provided with second heat-exchange flow guide structures 226. The flue gas can uniformly flow around heat-exchange-chamber heat-exchange tubes 21 through the second heat-exchange flow guide structures 226, avoiding dead corners in a flue gas flow process which affects the heat exchange efficiency of the heat exchanger 100.

Further, the heat-exchange-chamber fin through holes 221 are arranged in a plurality of rows along the flue gas flow direction. One second heat-exchange flow guide structure 226 is disposed at one side or two sides of a lower middle part of each heat-exchange-chamber fin through hole 221 in at least one row of the heat-exchange-chamber fin through holes 221 at a downstream side.

In an exemplary embodiment of the present disclosure, after passing through the upper part of the downstream row of the heat-exchange-chamber heat-exchange tubes 21 and exchanging heat with the heat-exchange-chamber heat-exchange tubes 21, the flue gas will converge at two sides of the lower middle part of the heat-exchange-chamber heat-exchange tubes 21, i.e., converge above the second heat-exchange flow guide structures 226. If the flue gas is not guided at this time, the flue gas will flow downward directly through slots, reducing the heat exchange efficiency. Therefore, the second heat-exchange flow guide structure 226 is arranged at one side or two sides of the lower middle part of the heat-exchange-chamber fin through hole 221 corresponding to the heat-exchange-chamber heat-exchange tube 21. In this way, the flue gas can be guided to the lower part of the heat-exchange-chamber heat-exchange tubes 21 at the downstream side, allowing the lower part of the heat-exchange-chamber heat-exchange tubes 21 in the one downstream row to be fully contacted with the flue gas, and the heat exchange efficiency to be improved.

Combined with the embodiments shown in FIG. 15, FIG. 17, and FIG. 18, one second heat-exchange flow guide structure 226 is disposed between two adjacent heat-exchange-chamber fin through holes 221 that are in a same row, such that the heat-exchange-chamber heat-exchange tubes 21 mounted in the two adjacent heat-exchange-chamber fin through holes 221 share the second heat-exchange flow guide structure 226 to simplify a structure. Therefore, the overall structure of the heat exchanger 100 is more compact, and more heat-exchange-chamber heat-exchange tubes 21 can be arranged in a limited space, which can improve the heat exchange efficiency.

Referring to FIG. 15, FIG. 17, and FIG. 18, each of the first heat-exchange flow guide structure 225 and the second heat-exchange flow guide structure 226 is constructed as an annular flange. In this way, the heat-exchange-chamber fin 22 can be manufactured by stamping, thereby reducing manufacture difficulty and production cost.

As shown in FIG. 15, FIG. 17, and FIG. 18, the heat-exchange-chamber fin 22 is further provided with third heat-exchange flow guide structures 227. The third heat-exchange flow guide structure 227 is located at two sides of one downstream row of the heat-exchange-chamber fin through holes 221. A pair of third heat-exchange flow guide structures 227 are provided and are disposed obliquely relative to each other, and a distance between the pair of third heat-exchange flow guide structures 227 decreases along the flue gas flow direction to guide flue gas toward one downstream row of the heat-exchange-chamber heat-exchange tubes 21.

Through the third heat-exchange flow guide structure 227, the flue gas can uniformly flow around the heat-exchange-chamber heat-exchange-tubes 21, and dead corners in the flue gas flow process, which affects the heat exchange efficiency of the heat exchanger 100, are avoided.

In the related art, the heat exchanger 100 of the water heater 1000 can achieve first-class energy efficiency through condensation heat exchange, and after condensation heat exchange, the exhaust flue gas temperature of the heat exchanger 100 can be reduced to below a dew point. Therefore, in the condensation heat exchange process, water vapor in flue gas condenses to generate condensed water, and a large number of acidic substances exist in the condensed water, which corrodes the wall surface of the heat exchanger 100 and affects the service life of the heat exchanger 100.

To avoid corrosion of acidic liquid on the wall surface of heat exchanger 100, the wall surface of heat exchanger 100 is usually made of stainless steel, which is corrosion-resistant but heat-resistant to a lesser extent. As a result, the wall surface of the combustion chamber 10 is damaged at a high temperature, which not only affects the service life of the heat exchanger 100 but may even cause a fire. The service life of the heat exchanger 100 is short, and the safety performance of the water heater 1000 is poor.

To this end, the embodiments of the present disclosure design a heat exchanger 100 with a heat insulation structure 11 adjacent to the combustion chamber wall. In this way, heat radiated inside the combustion chamber 10 or heat in the high-temperature flue gas inside the combustion chamber 10 can be insulated or absorbed by the heat insulation structure 11, preventing a large amount of heat from being transferred to the wall surface of the combustion chamber 10 to cause damage to the wall surface of the combustion chamber 10 under a high-temperature environment. The service life of the heat exchanger 100 is prolonged, and the safety performance of the water heater 1000 is improved.

The heat exchanger 100 further includes a heat insulation structure 11. The heat insulation structure 11 is disposed within the combustion chamber 10 and is adjacent to at least a part of a combustion chamber wall of the combustion chamber 10. In this way, heat radiated inside the combustion chamber 10 or heat in the high temperature flue gas inside the combustion chamber 10 can be insulated or absorbed by the heat insulation structure 11, preventing a large amount of heat from being transferred to the wall surface of the combustion chamber 10 to cause damage to the wall surface of the combustion chamber 10 under a high-temperature environment. The service life of the heat exchanger 100 is prolonged, and the safety performance of the water heater 1000 is improved.

According to the heat exchanger 100 of the embodiments of the present disclosure, the heat exchanger 100 is capable of avoiding the high temperature of the combustion chamber wall surface, and the combustion chamber wall surface is less susceptible to the high temperature of the combustion chamber 10, improving the service life of the heat exchanger 100, and improving the safety performance of the water heater 1000.

As shown in FIG. 15, the heat insulation structure 11 includes an insulation layer 111, which mainly serves to insulate heat and avoid heat transfer to the wall surface, thus preventing the wall surface from being damaged at a high temperature.

In some embodiments, the insulation layer 111 may be insulation wool, which is better shaped while ensuring an insulation effect of the insulation layer 111.

Referring to FIG. 25, the heat insulation structure 11 has an avoidance portion, to allow a part of structures to pass through the heat insulation structure 11 and interact with structures within the combustion chamber 10. In some embodiments, the avoidance portion avoids an ignition member 101 and/or a fire observation window 102 at the housing 40. The ignition member 101 is provided at the wall surface of the combustion chamber 10 and is for ignition. Maintenance personnel can observe combustion of the gas mixture in the combustion chamber 10 through the fire observation window 102, which facilitates maintenance.

As shown in FIG. 25, the insulation layer 111 has insulation layer through holes 1111. An arrangement of the through holes 61 can make the combustion chamber wall surface to be in communication with the combustion chamber 10, thereby avoiding an arrangement of the insulation layer 111 from affecting a normal arrangement of a gas structure while ensuring a heat insulation effect of the insulation layer 111. The insulation layer through holes 1111 are configured as the avoidance portion.

Referring to FIG. 15, the insulation layer 111 is fixed to an inner wall surface of the combustion chamber wall to ensure mounting stability of the insulation layer 111, which can avoid disengagement of the insulation layer 111 from the wall surface and ensure insulation effect of the insulation layer 111.

Combined with the embodiments shown in FIG. 15 and FIG. 21 to FIG. 24, the combustion chamber wall is provided with combustion-chamber wall flanges 45. The combustion-chamber flanges are respectively located at two longitudinal ends of the heat insulation layer 111 and used to fix the heat insulation layer 111. The insulation layer 111 is fixed by the combustion-chamber wall flanges 45, which ensures the mounting stability of the insulation layer 111. Moreover, structural redundancy caused by fixing the insulation layer 111 with other structures can be avoided, and this fixing manner is more suitable for the fixing of the insulation layer 111 in a high-temperature environment.

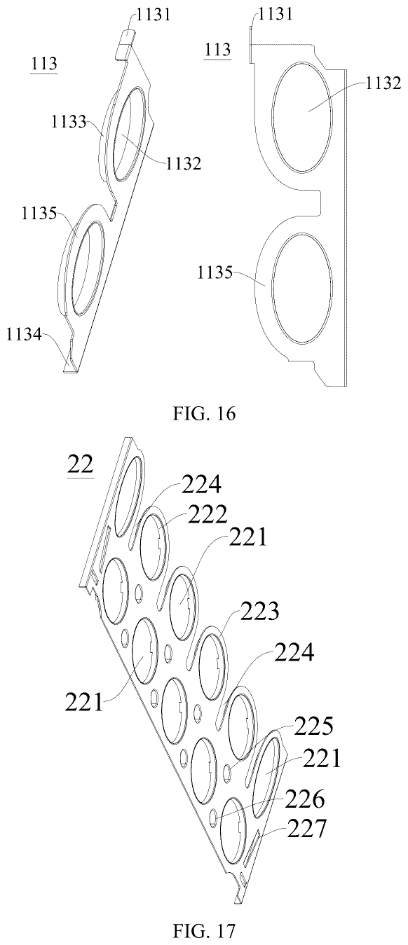

As shown in FIG. 15 and FIG. 16, the heat exchanger 100 further includes the combustion-chamber heat-exchange tubes 112. The combustion-chamber heat-exchange tubes 112 are provided in the combustion chamber 10 and form a part of the heat insulation structure 11. The combustion-chamber heat-exchange tubes 112 are located at a bottom of the heat insulation layer 111 and are used to insulate heat radiated from flames (i.e., flue gas) in the combustion chamber 10 to the combustion chamber wall.

That is to say, the combustion-chamber heat-exchange tubes 112 in the combustion chamber 10 can absorb heat generated by thermal radiation and heat of high-temperature flue gas, and exchange heat with water in the combustion-chamber heat-exchange tubes 112. An arrangement of the combustion-chamber heat-exchange tubes 112 can absorb a temperature of the combustion chamber wall surface, avoiding a high temperature of the combustion chamber wall surface causing injuries to the personnel, and preventing the wall surface of the combustion chamber 10 from being damaged in a high-temperature environment. In addition, the service life of the heat exchanger 100 is improved, and the safety performance of the water heater 1000 is improved.

As shown in FIG. 15 and FIG. 16, a combustion-chamber fin 113 is arranged around the combustion-chamber heat-exchange tubes 112 and is provided with a support flange 1131 used to support the heat insulation layer 111. In this way, the insulation layer 111 is limited at two longitudinal ends and two lateral sides of the insulation layer 111 by combustion-chamber wall flanges 45 provided at the combustion chamber wall, respectively. The support flange 1131 provided at the combustion-chamber fin 113 supports the insulation layer 111 at a lower side of the insulation layer 111, and can stably fix the insulation layer 111, to ensure the insulation layer 111 stably performs a function of heat insulation.

As shown in FIG. 15 and FIG. 16, the combustion-chamber fin 113 has combustion-chamber fin through holes 1132 and is provided with combustion-chamber fin flanges 1133 surrounding the combustion-chamber fin through holes 1132. The combustion-chamber heat-exchange tubes 112 penetrate through the combustion-chamber fin through holes 1132 and are fixed to the combustion-chamber fin flanges 1133, to ensure mounting stability between the combustion-chamber heat-exchange tubes 112 and the combustion-chamber fin 113.

Therefore, the combustion-chamber heat-exchange tubes 112 and the combustion-chamber fin 113 together form a tube-fin structure, to perform convective heat exchange with the flue gas, thereby ensuring sufficient contact area between the combustion-chamber heat-exchange tubes 112 and the flue gas, and improving the heat exchange efficiency.

Further, since the combustion-chamber fin 113 is connected to all the combustion-chamber heat-exchange tubes 112 at the same side at the same time, the temperature of respective combustion-chamber heat-exchange tubes 112 at the same side is ensured to be uniform, which further improves the heat exchange efficiency.

Referring to FIG. 15 and FIG. 16, the combustion-chamber fin 113 is further provided with a combustion-chamber fin edging 1134. The combustion-chamber fin edging 1134 is fixed to the combustion chamber wall. The combustion-chamber fin 113 can be integrally fixed to the combustion chamber wall through a fixing connection between the combustion-chamber fin edging 1134 and the combustion chamber wall, and the combustion-chamber heat-exchange tubes 112 can be further fixed, which ensures the stability of the overall arrangement.

Referring to FIG. 15 and FIG. 16, the combustion-chamber fin 113 is provide with a combustion-chamber fin surround member 1135 surrounding each of the combustion-chamber fin through holes 1132. At least one section of the combustion-chamber fin surround member 1135 is configured as a temperature evening section of the combustion-chamber fin 113 tending to be equal in width. Therefore, a size between a tube wall of the combustion-chamber heat-exchange tubes 112 corresponding to the combustion-chamber fin through holes 1132 corresponding to this section and an edge of the combustion-chamber fin 113 is uniform. Temperature of the tube walls of corresponding combustion-chamber heat-exchange tubes 112 in all directions can further be uniformly distributed, allowing the tube wall of the combustion-chamber heat-exchange tube 112 to uniformly exchange heat. In this way, an influence of uneven temperatures on the service life of the combustion-chamber fin 113 and the service life of the combustion-chamber heat-exchange tube 112 can be avoided.

Referring to FIG. 15 and FIG. 16, the temperature evening section of the combustion-

chamber fin 113 is located at a side of the corresponding combustion-chamber fin through hole 1132 facing towards a center of the combustion chamber 10. A temperature of the high-temperature flue gas received by this section is relatively high, and the energy of heat radiation is also relatively high. The heat exchange between the high-temperature flue gas and the combustion-chamber heat-exchange tube 112 has a great influence on the service life of the combustion-chamber heat-exchange tube 112. By designing a temperature evening section of the combustion-chamber fin 113 to correspond to the center of the combustion chamber 10, uniform temperature at a corresponding position can be ensured, and the influence of uneven temperature on the service life of the combustion-chamber fin 113 and the service life of the combustion-chamber heat-exchange tube 112 can be avoided.

In combination with the embodiments shown in FIG. 15, FIG. 17, and FIG. 18, a temperature evening section of the combustion-chamber fin 113 has a central angle of greater than or equal to 45 degrees, to ensure that the combustion-chamber fin 113 and the combustion-chamber heat-exchange tubes 112 have an area large area enough to maintain even temperature and to ensure the service life of the heat-exchange-chamber fin 22 and the service life of the heat-exchange-chamber heat-exchange tube 21.

Referring to FIG. 15, along the flue gas flow direction in the heat exchanger 100, the condensation chamber 30 is located below the combustion chamber 10 and the heat exchange chamber 20. Thus, the flue gas flow direction is the same as a flow direction of condensed water, avoiding the condensed water converging on the wall surface and improving the service life of the heat exchanger 100.

Further, the heat exchange chamber 20 is located between the combustion chamber 10 and the condensation chamber 30. In this way, the flue gas flow direction in the heat exchanger 100 is from top to bottom. The flue gas is generated in the combustion chamber 10, and flows from top to bottom to the heat exchange chamber 20. The flue gas exchanges heat with the heat-exchange-chamber heat-exchange tubes 21, and then flows to the condensation chamber 30 to perform condensation heat exchange with the condensation-chamber heat-exchange tubes 31. The flue gas after two-stages heat exchange is discharged from heat exchanger 100.

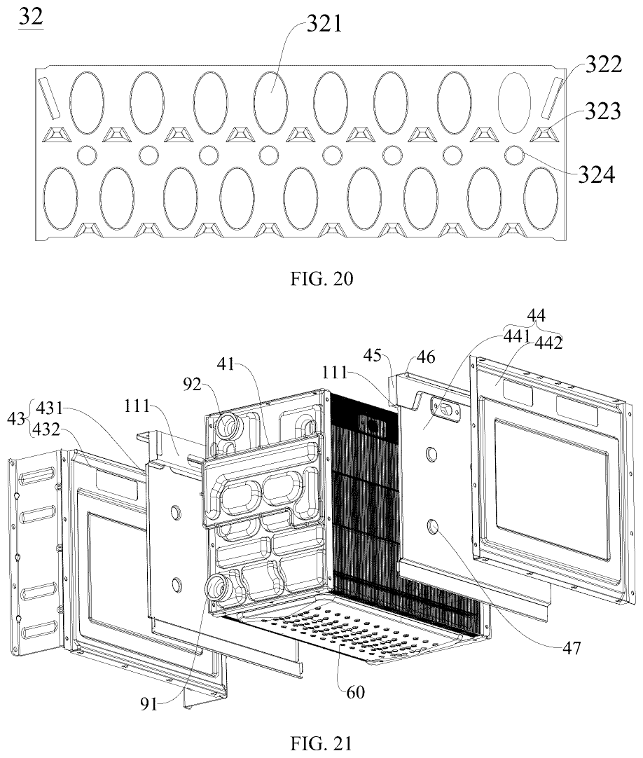

As shown in FIG. 15, FIG. 19, and FIG. 20, condensation-chamber fins 32 are arranged around at least some of condensation-chamber heat-exchange tubes 31. As shown in FIG. 15, the condensation-chamber heat-exchange tubes 31 are arranged in three rows along the flue gas flow direction, and the condensation-chamber fins 32 are arranged around two upstream rows of the condensation-chamber heat-exchange tubes 31.

The condensation-chamber fins 32 has at least one row of condensation-chamber fin through holes 321 and is provided with first condensation flow guide structures 322 used to guide flue gas to the condensation-chamber heat-exchange tubes 31. The flue gas can flow to the condensation-chamber heat-exchange tubes 31 through the first condensation flow guide structures 322, avoiding loss in the flue gas flow process and affecting the heat exchange efficiency of the heat exchanger 100.

Referring to FIG. 15, FIG. 19, and FIG. 20, the condensation-chamber fin through holes 321 are arranged in a plurality of rows along the flue gas flow direction. The first condensation flow guide structures 322 are located at two longitudinal ends of a most upstream row of condensation-chamber fin through holes 321 along the flue gas flow direction. Therefore, flue gas flowing from an edge of the heat exchange chamber 20 downward to an edge of the condensation chamber 30 is guided by the first condensation flow guide structures 322 and converges in a middle of the condensation chamber 30, allowing the flue gas to better exchange heat with the condensation-chamber heat-exchange tubes 31.

As shown in FIG. 15, FIG. 19, and FIG. 20, a pair of first condensation flow guide structures 322 are provided and are disposed obliquely relative to each other, and a distance between the pair of first condensation flow guide structures 322 decreases along the flue gas flow direction to guide flue gas to the condensation-chamber heat-exchange tubes 31. In this way, the flue gas flowing from the edge of the heat exchange chamber 20 downward to the edge of the condensation chamber 30 is guided by the first condensation flow guide structures 322 and converges in the middle of the condensation chamber 30, allowing the flue gas to better exchange heat with the condensation-chamber heat-exchange tubes 31.

Referring to FIG. 15, FIG. 19, and FIG. 20, the condensation-chamber fin 32 is further provided with second condensation flow guide structures 323. The flue gas can flow uniformly around the condensation-chamber heat-exchange tubes 31 through the second condensation flow guide structures 323, avoiding dead corners existing in the flue gas flow process and affecting the heat exchange efficiency of the heat exchanger 100.

The second condensation flow guide structure 323 is located at one side or two sides of a lower middle part of each condensation-chamber fin through hole 321 and is used to guide flue gas to a lower middle part of the corresponding condensation-chamber heat-exchange tube 31. In an exemplary embodiment of the present disclosure, after passing through an upper half part of the condensation-chamber heat-exchange tube 31 and exchanging heat with the upper half part of the condensation-chamber heat-exchange tube 31, the flue gas reaches two sides of the condensation-chamber heat-exchange tube 31. If the flue gas is not guided at this time, the flue gas will flow downstream directly. A lower half part of the condensation-chamber heat-exchange tube 31 cannot contact the flue gas, resulting in a poor heat exchange effect.

Therefore, by arranging the second condensation flow guide structures 323 at one side or two sides of the lower middle part of each condensation-chamber fin through hole 321, flue gas can flow to the lower half part of the condensation-chamber heat-exchange tube 31 after flowing through the upper half part of the condensation-chamber heat-exchange tube 31. In this way, the upper part and the lower part of the condensation-chamber heat-exchange tube 31 can be fully contacted with the flue gas, and the heat exchange efficiency is improved.

As shown in FIG. 15, FIG. 19, and FIG. 20, one second condensation flow guide structure 323 is disposed between two adjacent condensation-chamber fin through holes 321 that are in a same row, to allow the condensation-chamber heat-exchange tubes 31 mounted in the two adjacent condensation-chamber fin through holes 321 to share the one second condensation flow guide structure 323, simplifying the structure. The overall structure of the heat exchanger 100 is more compact, and more condensation-chamber heat-exchange tubes 31 can be arranged in a limited space, which allows the heat exchange efficiency to be improved.

According to some embodiments of the present disclosure, the second condensation flow guide structure 323 is configured as a flow guide structure with a narrow top and a wide bottom, to allow two side surfaces of the second condensation flow guide structure 323 to form inclined surfaces suitable for guiding flue gas. The top of the second condensation flow guide structure 323 is located at an upstream side of the bottom of the second condensation flow guide structure 323 along the flue gas flow direction.

In some embodiments, the second condensation flow guide structure 323 may be configured as a trapezoidal flange structure. In other embodiments, the second condensation flow guide structure 323 may be configured as a triangular structure, which are not limited herein.

In an exemplary embodiment of the present disclosure, referring to FIG. 15, FIG. 19, and FIG. 20, the flue gas at the upstream side flows downstream to reach the top of the second condensation flow guide structure 323. The flue gas is guided by two side surfaces of the second condensation flow guide structure323, respectively, and then flows to two sides respectively under a guidance of the second condensation flow guide structure 323. The flue gas can further flow to the lower half part of the condensation-chamber heat-exchange tube 31.

According to some embodiments of the present disclosure, the condensation-chamber fin through holes 321 are arranged in the plurality of rows along the flue gas flow direction, and the condensation-chamber fin 32 is further provided with a third condensation flow guide structure 324 between two adjacent rows of the condensation-chamber fin through holes 321. The third condensation flow guide structure 324 is used to guide flue gas from an upstream side to the condensation-chamber heat-exchange tubes 31 at a downstream side. Therefore, the flue gas converging above the third condensation flow guide structure 324 can be uniformly guided to the upper part of the condensation-chamber heat-exchange tubes 31 located at two sides of the third condensation flow guide structure 324 and located at the downstream side.

In addition, along the flue gas flow direction, one third condensation flow guide structure 324 is provided between two above parts of each two adjacent through holes 61 in a downstream row of the condensation-chamber fin through holes 321 and the third condensation flow guide structure 324 is further located directly below one corresponding condensation-chamber fin through hole 321 at an upstream side.

That is to say, the flue gas flows to the top of the second condensation flow guide structure 323 after flowing through the upper half part of the condensation-chamber heat-exchange tubes 31. The flue gas is guided by the two side surfaces of the second condensation flow guide structure 323, respectively, and then flows to the lower half part of the condensation-chamber heat-exchange-tubes 31 at two sides respectively under the guidance of the second condensation flow guide structure 323. The flue gas flows through the lower part of the condensation-chamber heat-exchange tubes 31 at the upstream side and reaches the upper part of the third condensation flow guide structure 324. The flue gas converging above the third condensation flow guide structure 324 can be uniformly guided to the upper part of the condensation-chamber heat-exchange tubes 31 at the downstream side at two sides of the third condensation flow guide structure 324.

Referring to FIG. 15, FIG. 19, and FIG. 20, the third condensation flow guide structure 324 is configured as an annular flange. Therefore, the condensation-chamber fin 32 can be manufactured by stamping, reducing manufacture difficulty and production cost.

As shown in FIG. 15, FIG. 19, and FIG. 20, a number of rows of the condensation-chamber fin through holes 321 arranged on the condensation-chamber fin 32 is smaller than a number of rows of the condensation-chamber heat-exchange tubes 31, simplifying the structure and reducing the production cost while ensuring the heat exchange efficiency of the heat exchanger 100.

At least one row of the condensation-chamber heat-exchange tubes 31 adjacent to an upstream side among the plurality of rows of the condensation-chamber heat-exchange tubes 31 is fit in at least one corresponding row of the condensation-chamber fin through holes 321. At least one row of the condensation-chamber heat-exchange tubes 31 located at a downstream side is entirely located at the downstream side of the condensation-chamber fin 32. Therefore, the condensation-chamber heat-exchange tubes 31 located at the upstream side obtain a larger heat exchange area through the fin, and can exchange heat with flue gas with a higher temperature, and the heat exchange effect is better.

Referring to FIG. 1 to FIG. 3, and in conjunction with the embodiment shown in FIG. 21, the housing 40 includes a left side plate assembly 41, a right side plate assembly 42, a front side plate assembly 43, and a rear side plate assembly 44. The left side plate assembly 41, the rear side plate assembly 44, the right side plate assembly 42, and the front side plate assembly 43 encloses and are fixed, i.e., the heat exchange chamber 20 and the condensation chamber 30 of heat exchanger 100 are integrally provided. Therefore, an overall structure of the housing 40 is compact. Since the flue gas flows from top to bottom along the same direction as a flow direction of condensed water, the condensation chamber 30 is not easy to gather on the wall surface, avoiding a corrosion of the housing 40.

In the related art, the flue gas is directly discharged from an exhaust gas channel after condensation heat exchange. Since the heat exchange between the flue gas and the heat exchanger 100 is insufficient and an exhaust flue gas has relatively high temperature, the heat exchange efficiency of the heat exchanger 100 is low.

Therefore, the embodiments of the present disclosure design a heat exchanger 100 provided with a flue gas block structure 60 at the downstream of the condensation chamber 30. The flue gas block structure 60 can increase the resistance of the flue gas flowing out of the condensation chamber 30, and increase a residence duration of the flue gas in the condensation chamber 30. In this way, the flue gas exchange sufficient heat with the condensation-chamber heat-exchange tubes 31, reducing the exhaust flue gas temperature, and improving a thermal efficiency of the heat exchanger 100.

The heat exchanger 100 further includes the flue gas block structure 60. The flue gas block structure 60 is disposed at the downstream side of the condensation chamber 30 along the flue gas flow direction in the heat exchanger 100. The flue gas block structure 60 has a through hole 61 of the flue gas block structure 60 for condensed water and flue gas to pass through.

The flue gas block structure 60 can increase the resistance of the flue gas flowing out of the condensation chamber 30, and increase the residence duration of the flue gas in the condensation chamber 30. The flue gas can exchange sufficient heat with the condensation-chamber heat-exchange tubes 31, reducing the exhaust flue gas temperature, and improving the thermal efficiency of the heat exchanger 100.

According to the heat exchanger 100 of the embodiments of the present disclosure, the heat exchanger 100 can increase the resistance of the flue gas flowing out of the condensation chamber 30, and increase the residence duration of the flue gas in the condensation chamber 30. In this way, the flue gas can exchange sufficient heat with the condensation-chamber heat-exchange tubes 31, reducing the exhaust gas temperature, and improving the thermal efficiency of the heat exchanger 100.

As shown in FIG. 1 and FIG. 15, in some embodiments, the flue gas flows from top to bottom, and the flue gas block structure 60 is provided at a bottom of housing 40 to increase flue gas resistance when the flue gas exits the condensation chamber 30.

As shown in FIG. 15, the condensation chamber 30 is located above the flue gas block structure 60, and at least a part of the flue gas block structure 60 protrudes away from the condensation chamber 30. Therefore, a flue gas gathering cavity 62 is formed in the flue gas block structure 60. When the flue gas flows into the flue gas gathering cavity, the flue gas will converge to a bottom of the flue gas gathering cavity 62 under a guidance of the wall surface of the flue gas block structure 60.

That is to say, the heat exchanger 100 can realize the convergence of the flue gas and the condensed water through the arrangement of the flue gas block structure 60, and does not need a special design of the condensation chamber 30. In addition, the overall structure is compact, and a space in the condensation chamber 30 is large. More condensation-chamber heat-exchange tubes 31 can be arranged in the condensation chamber 30, improving the heat exchange efficiency.

Referring to FIG. 15, a peripheral area of the flue gas block structure 60 is higher than a central area of the flue gas block structure 60, allowing condensed water can converge toward the central area of the flue gas block structure 60. In this way, a flow of the condensed water can be facilitated through gravity to facilitate an outflow of the condensed water.

In an exemplary embodiment of the present disclosure, as shown in FIG. 26, the flue gas block structure 60 includes a first flue gas block plate 63 and a second flue gas block plate 64. Adjacent longitudinal edges of the first flue gas block plate 63 and the second flue gas block plate 64 adjacent to each other are connected. Away longitudinal edges of the first flue gas block plate 63 and the second flue gas block plate 64 away from each other are connected to housing 40. Therefore, the flue gas block structure 60 and the housing 40 can form an integral structure. The adjacent longitudinal edge of the first flue gas block plate 63 and the second flue gas block plate 64 is lower than the away longitudinal edge of the first flue gas block plate 63 and the second flue gas block plate 64. Thus, the flue gas block structure 60 is low in the center and high in the periphery, and the condensed water is directed by the first flue gas block plate 63 and the second flue gas block plate 64 to converge in the center of the flue gas block structure 60.

Referring to FIG. 26, two adjacent longitudinal edges of the first flue gas block plate 63 and the second flue gas block plate 64 are connected through a transition flat plate 65. The transition flat plate 65 may have more through holes 61, and the flue gas and the condensed water can flow out of the condensation chamber 30 through the through holes 61 at the transition flat plate 65.

According to some embodiments of the present disclosure, the heat exchanger 100

further includes a water collecting tray disposed at the downstream side of the flue gas block structure 60 along the flue gas flow direction. The water collecting tray is connected to a water seal structure 800 and the exhaust flue gas channel. Thus, condensed water collected by the flue gas block structure 60 can flow downward into the water collecting tray and can exit the heat exchanger 100 through the water seal structure 800, while the flue gas can flow upward and exit the heat exchanger 100 through the exhaust flue gas channel.

Referring to FIG. 21, the front side plate assembly 43 includes a front heat insulation plate 431 and a front decorative plate 432 disposed outside the front heat insulation plate 431. The front heat insulation plate 431 and the front decorative plate 432 are spaced apart from each other, to further isolate heat transfer by utilizing a space between the front heat insulation plate 431 and the front decorative plate 432, and prevent the front decorative plate 432 from being overheated. And/or, the rear side plate assembly 44 includes a rear heat insulation plate 441 and a rear decorative plate 442 disposed outside the rear heat insulation plate 441. The rear heat insulation plate 441 and the rear decorative plate 442 are spaced apart from each other, to further isolate heat transfer by utilizing a space between the rear heat insulation plate 441 and the rear decorative plate 442, and prevent the rear decorative plate 442 from being overheated.

A protrusion structure 47 is provided at an outer surface of the front heat insulation plate 431 and/or the rear heat insulation plate 441, to maintain the front heat insulation plate 431 and the front decorative plate 432 spaced apart from each other or the rear heat insulation plate 441 and the rear decorative plate 442 spaced apart from each other.

Upper ends of the front heat insulation plate 431 and the rear heat insulation plate 441 have an outward second flange 46, which can prevent flue gas from entering between the front heat insulation plate 431 and the front decorative plate 432 or between the rear heat insulation plate 441 and the rear decorative plate 442, avoiding flue gas leakage. In addition, low-temperature corrosion damage to the housing 40 caused by flue gas between the front heat insulation plate 431 and the front decorative plate 432 or between the rear heat insulation plate 441 and the rear decorative plate 442 is avoided, and the service life of the heat insulation plate is prolonged.

In combination with the embodiment shown in FIG. 1 to FIG. 3, each of the left side plate assembly 41 and the right side plate assembly 42 is configured as a part of a water box used to form a water circulation, simplifying the structure. Therefore, the heat exchanger 100 has a compact overall structure, reducing a size of the heat exchanger 100. The water box is utilized to cool down the wall surface, to prevent overheating of the heat exchanger 100 from causing injury to the maintenance personnel.

According to the water heater 1000 of the embodiments of the present disclosure, the water heater 1000 has a higher energy efficiency by adopting the heat exchanger 100 described above.

A specific embodiment of the water heater 1000 is described below in conjunction with the accompanying drawings.

As shown in FIG. 1 to FIG. 26, the water heater 1000 includes the heat exchanger 100. The gas burns in the combustion chamber 10 of the heat exchanger 100, and heat radiation and high-temperature flue gas generated in a combustion process can exchange heat in the heat exchanger 100, thereby achieving the purpose of heating cold water.

As shown in FIG. 27, the water heater 1000 further includes an air inlet base 300 and an air inlet 301 formed at the air inlet base 300. Air can enter an air inlet channel of the water heater 1000 through the air inlet 301.

The water heater 1000 further includes a gas pipeline 1001 and a gas inlet 1002. The gas can enter the gas pipeline 1001 through the gas inlet 1002.

The water heater 1000 also includes a premixer 400, a fan 500, a hush pipe 1007, and a combustor 600. The air inlet channel and the gas pipeline 1001 are in communication with the premixer 400, are mixed to be mixed gas in premixer 400. The mixed gas enters the hush pipe 1007 by driving of the fan 500 and is transferred to the combustor 600 through the hush pipe 1007. The combustor 600 is in communication with the combustion chamber 10 of the heat exchanger 100. The mixed gas can be ignited in the combustion chamber 10 of the heat exchanger 100 by the ignition member 101. Under an action of the fan 500, the flue gas in the heat exchanger 100 flows from top to bottom.

The water heater 1000 further includes a water seal structure 800, a flue gas outlet base 200, and a flue gas outlet 201. The flue gas after heat exchange is formed into low-temperature flue gas and condensed water. The condensed water is collected by the water collecting tray and can be discharged out of the water heater 1000 through the water seal structure 800. The low-temperature flue gas can be discharged out of the water heater 1000 through the flue gas outlet 201 disposed at the flue gas outlet base 200.

The water heater 1000 further includes a water inlet pipeline 900, a cold water inlet 901, and a hot water outlet 1003. Cold water enters the water inlet pipeline 900 through the cold water inlet 901, and the water inlet pipeline 900 is in communication with a water circuit of the heat exchanger 100. The cold water enters the water circuit of the heat exchanger 100 through the water inlet 91 of the heat exchanger 100, and exchanges heat in the heat exchanger 100. The water temperature rises in the process, and finally hot water is discharged out of the heat exchanger 100 through the water outlet 92. The water outlet 92 of the heat exchanger 100 is further in communication with the hot water outlet 1003 of the water heater 1000, thereby enabling the hot water to exit the water heater 1000 and be input into a water consuming appliance.

The water heater 1000 further includes a controller 700, a water proportional valve 1004, a gas proportional valve 1005, a water flow sensor 1006, and a wind pressure transducer 1008. The controller 700 communicates with the water flow sensor 1006 and the wind pressure transducer 1008, and controls the fan 500, the water proportional valve 1004, and the gas proportional valve 1005 to better control a temperature of hot water produced by the water heater 1000 and a production efficiency of hot water produced by the water heater 1000.

Other configurations in the water heater are known to those skilled in the art and are therefore not described in detail herein.

In the description of this specification, description with reference to the terms “an embodiment”, “some embodiments”, “exemplary embodiments”, “examples” “specific examples”, or “some examples” etc., mean that specific features, structure, materials or characteristics described in conjunction with the embodiment or example are included in at least one embodiment or example of the present disclosure. Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

1.-54. (canceled)

55. A heat exchanger comprising:
a housing;
a combustion chamber, a heat exchange chamber, and a condensation chamber provided inside the housing and sequentially arranged along a flue gas flow direction in the housing;
combustion-chamber heat-exchange tubes provided in the combustion chamber;
heat-exchange-chamber heat-exchange tubes provided in the heat exchange chamber and in communication with the combustion-chamber heat-exchange tubes; and
condensation-chamber heat-exchange tubes provided in the condensation chamber and in communication with the heat-exchange-chamber heat-exchange tubes.

56. The heat exchanger according to claim 55, wherein:
the condensation-chamber heat-exchange tubes are arranged in a plurality of rows along the flue gas flow direction; and
at least some of the condensation-chamber heat-exchange tubes are arranged into a plurality of groups each including at least two condensation-chamber heat-exchange tubes arranged in parallel.

57. The heat exchanger according to claim 56, wherein:
at least two condensation-chamber heat-exchange tubes in a same one of the plurality of rows are connected in parallel; and/or
at least two condensation-chamber heat-exchange tubes respectively in at least two adjacent ones of the plurality of rows are connected in parallel.

58. The heat exchanger according to claim 56, wherein:
the condensation-chamber heat-exchange tubes are arranged in three rows, including an upstream row, a midstream row, and a downstream row along the flue gas flow direction;
each condensation-chamber heat-exchange tube in the downstream row is connected in parallel with a corresponding condensation-chamber heat-exchange tube in the midstream row; and
at least two adjacent condensation-chamber heat-exchange tubes in the upstream row are connected to each other in parallel.

59. The heat exchanger according to claim 58, wherein a number of condensation-chamber heat-exchange tubes in the downstream row and the midstream row that are in a parallel connection is greater than a number of condensation-chamber heat-exchange tubes in the upstream row that are in a parallel connection.

60. The heat exchanger according to claim 55, wherein:
the heat-exchange-chamber heat-exchange tubes are arranged in a plurality of rows along the flue gas flow direction, the heat-exchange-chamber heat-exchange tubes in each row being arranged in series; or
the combustion-chamber heat-exchange tubes are arranged in a plurality of rows along the flue gas flow direction, the combustion-chamber heat-exchange tubes in each row being arranged in parallel.

61. The heat exchanger according to claim 55, wherein each of the condensation-chamber heat-exchange tubes and the combustion-chamber heat-exchange tubes is an elliptical tube having a major axis parallel to the flue gas flow direction.

62. The heat exchanger according to claim 55, wherein at least one of the heat-exchange-chamber heat-exchange tubes is a circular tube and at least another one of the heat-exchange-chamber heat-exchange tubes is an elliptical tube having a major axis parallel to the flue gas flow direction.

63. The heat exchanger according to claim 62, wherein:
the heat-exchange-chamber heat-exchange tubes are arranged in a plurality of rows along the flue gas flow direction; and
a number of circular tubes in an upstream row of the heat-exchange-chamber heat-exchange tubes is smaller than a number of circular tubes in an adjacent downstream row of the heat-exchange-chamber heat-exchange tubes, and two tubes located at two ends in the upstream row of the heat-exchange-chamber heat-exchange tubes are elliptical tubes.

64. The heat exchanger according to claim 55, further comprising:
a heat-exchange-chamber fin arranged around one or more of the heat-exchange-chamber heat-exchange tubes, the heat-exchange-chamber fin having a heat-exchange-chamber fin through hole and a heat-exchange-chamber fin flange surrounding the heat-exchange-chamber fin through hole, and the one or more heat-exchange-chamber heat-exchange tubes penetrating through the heat-exchange-chamber fin through hole and being fixed to the heat-exchange-chamber fin flange.

65. The heat exchanger according to claim 55, further comprising:
a condensation-chamber fin disposed around one or more of the condensation-chamber heat-exchange tubes, the condensation-chamber fin having at least one row of condensation-chamber fin through holes and being provided with condensation flow guide structures configured to guide flue gas to the condensation-chamber heat-exchange tubes.

66. The heat exchanger according to claim 65, wherein the at least one row of condensation-chamber fin through holes is at least one of a plurality of rows of condensation-chamber fin through holes arranged along the flue gas flow direction, the condensation flow guide structures being located at two longitudinal ends of a most upstream row of condensation-chamber fin through holes along the flue gas flow direction.

67. The heat exchanger according to claim 66, wherein the condensation flow guide structures include two condensation flow guide structures disposed obliquely relative to each other, and a distance between the two condensation flow guide structures decreases along the flue gas flow direction.

68. The heat exchanger according to claim 65, wherein:
the condensation flow guide structures are first condensation flow guide structures; and
the condensation-chamber fin is further provided with second condensation flow guide structures, one or each of two sides of a lower middle part of each of the condensation-chamber fin through holes being provided with one of the second condensation flow guide structures, and each of the second condensation flow guide structures being configured to guide flue gas to a lower middle part of the corresponding condensation-chamber heat-exchange tube.

69. The heat exchanger according to claim 68, wherein one of the second condensation flow guide structures is disposed between two adjacent condensation-chamber fin through holes that are in a same row, to allow the condensation-chamber heat-exchange tubes mounted in the two adjacent condensation-chamber fin through holes to share the one second condensation flow guide structure.

70. The heat exchanger according to claim 68, wherein each second condensation flow guide structure is configured to have a narrow top and a wide bottom to allow two side surfaces of the second condensation flow guide structure to form inclined surfaces, and the top of the second condensation flow guide structure is located at an upstream side of the bottom of the second condensation flow guide structure along the flue gas flow direction.

71. The heat exchanger according to claim 65, wherein:
the condensation flow guide structures are first condensation flow guide structures;
the at least one row of condensation-chamber fin through holes is at least one of a plurality of rows of condensation-chamber fin through holes arranged along the flue gas flow direction; and
the condensation-chamber fin is further provided with a second condensation flow guide structure between two adjacent rows of condensation-chamber fin through holes, the second condensation flow guide structure being configured to guide flue gas from an upstream side to the condensation-chamber heat-exchange tubes at a downstream side.

72. The heat exchanger according to claim 71, wherein:
along the flue gas flow direction, the second condensation flow guide structure is:
provided above and between two adjacent condensation-chamber fin through holes that are in a downstream row along the flue gas flow direction, and
located right below one condensation-chamber fin through hole in an upstream row; or
the second condensation flow guide structure is configured as an annular flange.

73. The heat exchanger according to claim 65, wherein:
a number of rows of condensation-chamber fin through holes arranged on the condensation-chamber fin is smaller than a number of rows of condensation-chamber heat-exchange tubes;
at least one row of condensation-chamber heat-exchange tubes adjacent to an upstream side among the plurality of rows of condensation-chamber heat-exchange tubes is fit in at least one corresponding row of condensation-chamber fin through holes; and
at least one row of condensation-chamber heat-exchange tubes located at a downstream side is entirely located at the downstream side of the condensation-chamber fin.

74. A water heater comprising:
a heat exchanger including:
a housing;
a combustion chamber, a heat exchange chamber, and a condensation chamber provided inside the housing and sequentially arranged along a flue gas flow direction in the housing;
combustion-chamber heat-exchange tubes provided in the combustion chamber;
heat-exchange-chamber heat-exchange tubes provided in the heat exchange chamber and in communication with the combustion-chamber heat-exchange tubes; and
condensation-chamber heat-exchange tubes provided in the condensation chamber and in communication with the heat-exchange-chamber heat-exchange tubes.
